(19) United States
(12) Patent Application Publication
(10) Pub. No.: US 2011/0033291 A1
(43) Pub. Date: Feb. 10, 2011

(54) ENERGY TRANSFER SYSTEM

(75) Inventors: Doug Moore, Riesel, TX (US); Allen James Williston, Foristell, MO (US)

Correspondence Address: The Caldwell Firm, LLC, P.O. Box 59655, Dallas, TX, 75229, US

(73) Assignee: Abundant Energy, LLC, Plano, TX (US)

(21) Appl. No.: 12/534,856

(22) Filed: Aug. 4, 2009

(51) Int. Cl. F03D 11/02; F03D 3/00

(52) U.S. Cl. 416/1; 416/170 R; 416/169 R

(57) ABSTRACT

A system comprises an enclosure comprising an interior, a drive shaft opening, and a first auxiliary drive shaft opening. A drive gear is disposed within the enclosure. A first auxiliary gear is disposed within the enclosure. The enclosure aligns the drive gear and the first auxiliary gear such that the drive gear is configured to drive the first auxiliary gear. The drive gear couples to an end of a drive shaft. The first auxiliary gear couples to a first end of a first auxiliary drive shaft. The drive shaft extends from the interior through the drive shaft opening. The first auxiliary drive shaft extends from the interior through the first auxiliary drive shaft opening.

### TECHNICAL FIELD

The present invention relates generally to the field of electrical power generation using vertical turbines and, more particularly, to a system for improved wind energy transfer.

### BACKGROUND OF THE INVENTION

Electricity forms the backbone of modern society. Without electricity, much of the technology that brings order to the modern world would not function. As first-world nations continue to advance, and third-world nations industrialize and move into first-world status, the world faces increasing demands for electricity. Presently, commercial electrical generation primarily relies on electromagnetic induction, in which mechanical energy operates an electromagnetic induction generator to produce electricity. Generally, a power generation plant based on electromagnetic induction produces steam, and the steam causes a turbine to operate or spin. As the turbine spins, it produces power by operating an electromagnetic induction generator mechanically coupled to the turbine.

Production of steam requires a significant amount of energy. One method of steam production uses nuclear fission. In nuclear fission, a nuclear reaction occurs generating a large amount of heat. The nuclear power plant uses the heat generated by the nuclear reaction to boil water and produce steam. As described above, the nuclear power plant uses the produced steam to generate power. Unfortunately, nuclear power plants require significant capital to construct and operate. In many cases, the capital requirements limit use of nuclear power plants to those countries in which the government can subsidize the construction and operation of the plant, or to those countries where the individual consumer's wealth allows the consumer to afford an increased cost for the resultant electricity. In addition, the radiation produced by the nuclear reaction is extremely toxic, and the spent nuclear fuel remains radioactive for a significant period of time, which requires costly containment facilities for the spent fuel.

Another more common method of steam production for electrical power generation burns fossil fuels, such as coal, natural gas, and petroleum, to boil water and produce steam. This method of production avoids the risks of radioactive toxicity associated with nuclear power. Fossil fuels burn into a particulate matter that dissipates through the air, eliminating the need for expensive containment facilities associated with the radioactive fuel of nuclear reactors. Unfortunately, the particulate matter resulting from the combustion of fossil fuels contributes significantly to air pollution, which can cause problems of its own, including serious health problems for many individuals. When compared to nuclear power generation, startup costs to use fossil fuels to generate electricity are typically smaller. However, fossil fuels are a finite resource. As world demand for fossil fuels for electrical power generation and other uses increases, the world faces increased costs for fossil fuels, especially as fossil fuels begun to become scarce, potentially making fossil fuels cost prohibitive.

To combat problems with fossil fuels, some electrical power generation uses water and/or wind instead of steam to spin a turbine. Wind generation relies on naturally occurring wind or solar updraft towers that create wind artificially by using sunlight to heat air within a chimney. In both cases, power generation depends on the occurrence of a natural phenomenon. In the case of wind turbines, the turbine size necessary to generate appreciable electrical energy dictates fixation of the wind turbines to a specific location. Because the wind turbines are fixed, in the event that the wind ceases, the wind turbine ceases to generate electricity. Thus, wind turbines need an almost constant flow of wind; this limitation severely restricts suitable locations for wind turbine installation. In the case of a solar updraft tower, sunlight requirements limit installation to those areas that continually receive sunlight.

Conventional systems and methods using wind turbines to generate electricity rely on a single generator per wind turbine. When wind speeds slow, the rotational energy produced by the wind turbine often drops past the point at which the generator can produce electricity, or produce electricity efficiently. That is, typical wind generation systems do not include a system or methodology that allows for the production of electricity at slow wind speeds or that allows for scalable electricity production.

Moreover, conventional turbine braking also causes additional stress on the main drive shaft gearbox, shortening the life of the gearbox. For example, conventional turbine brakes generally consist of a single large brake located near to, but outside of, the gearbox. In instances where aggressive or sudden braking occurs, the shaft and gearbox experience two to three times the operating torque in a very short time span. To prevent breakage of turbine drive train components, turbine engineers generally include a high safety factor in the drive train design. The high safety factor greatly increases the costs of the wind turbine drive train components. Furthermore, the drive train high safety factor is often unhelpful in preventing system failure, due to failure in the flange welds coupling the drive train components together.

Therefore, there is a need for an improved wind energy transfer system that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

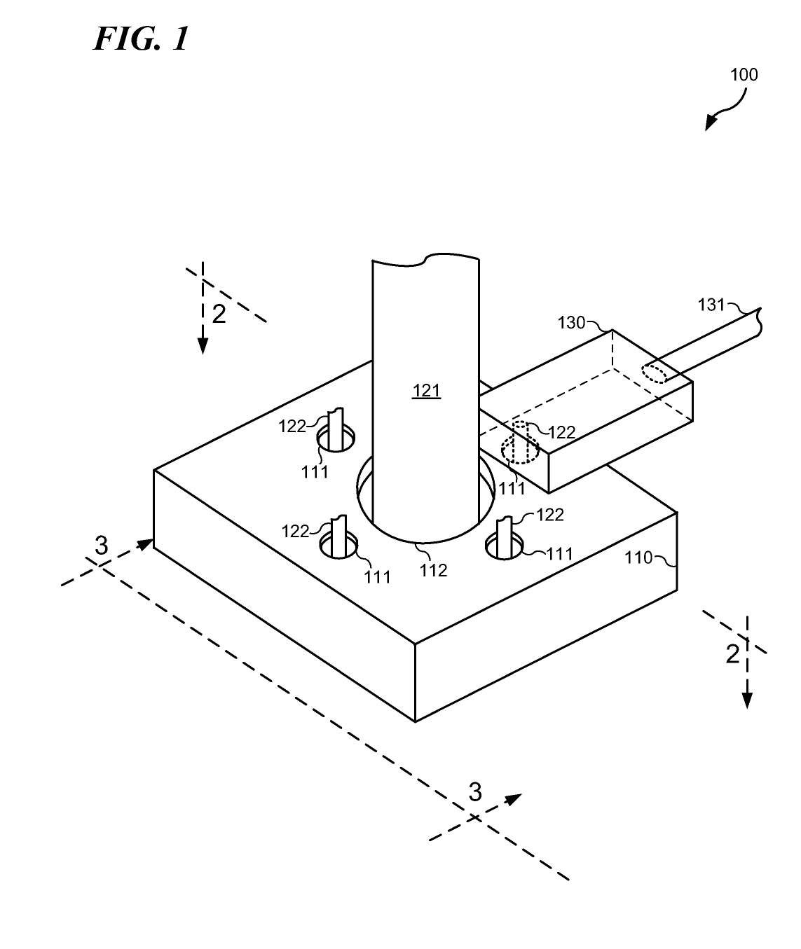

FIG. 1 provides a perspective representation illustrating exemplary elements in accordance with one embodiment;

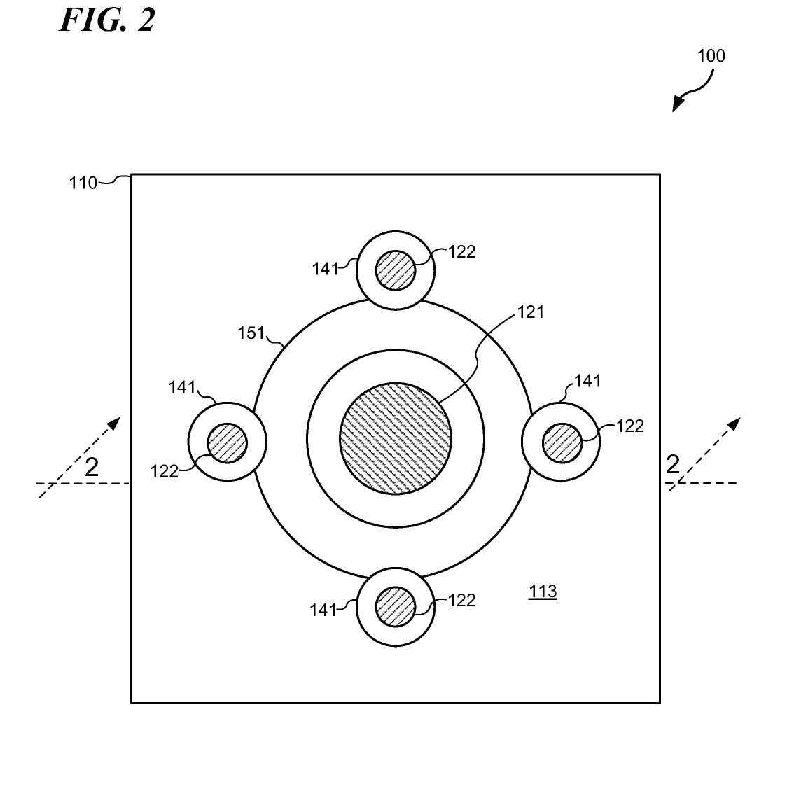

FIG. 2 provides a sectional representation of the embodiment of FIG. 1 taken along line 2-2;

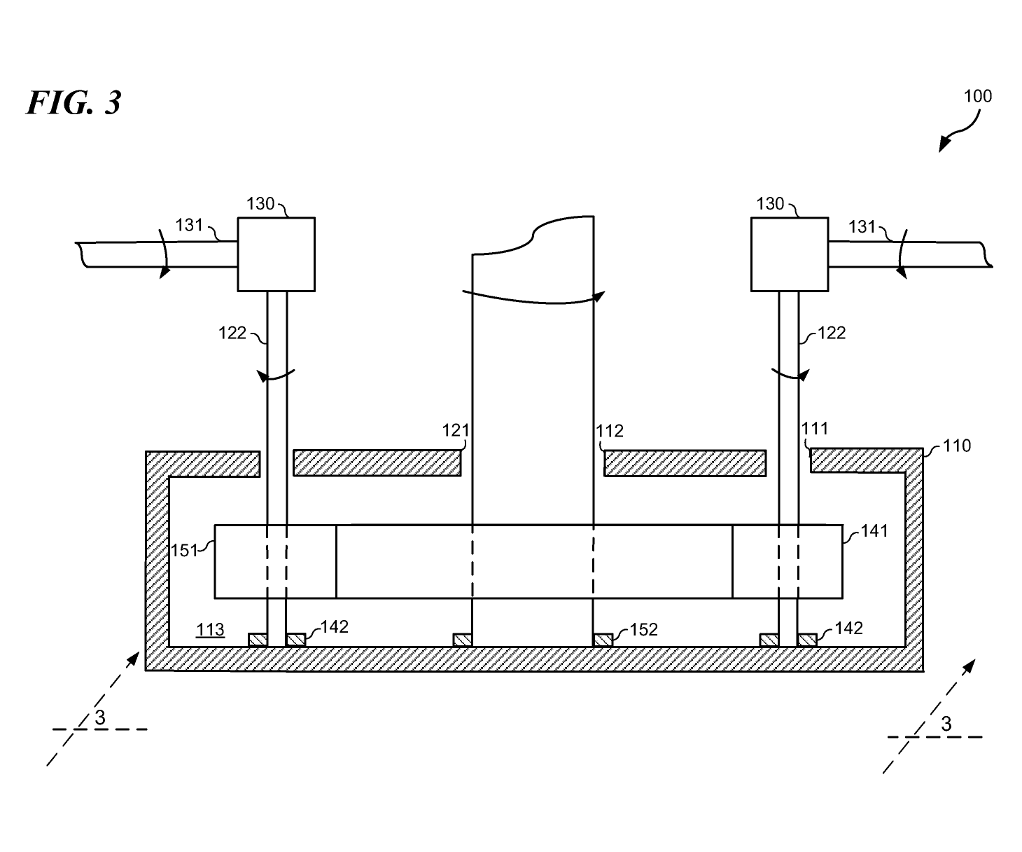

FIG. 3 provides a sectional representation of the embodiment of FIG. 1 taken along line 3-3;

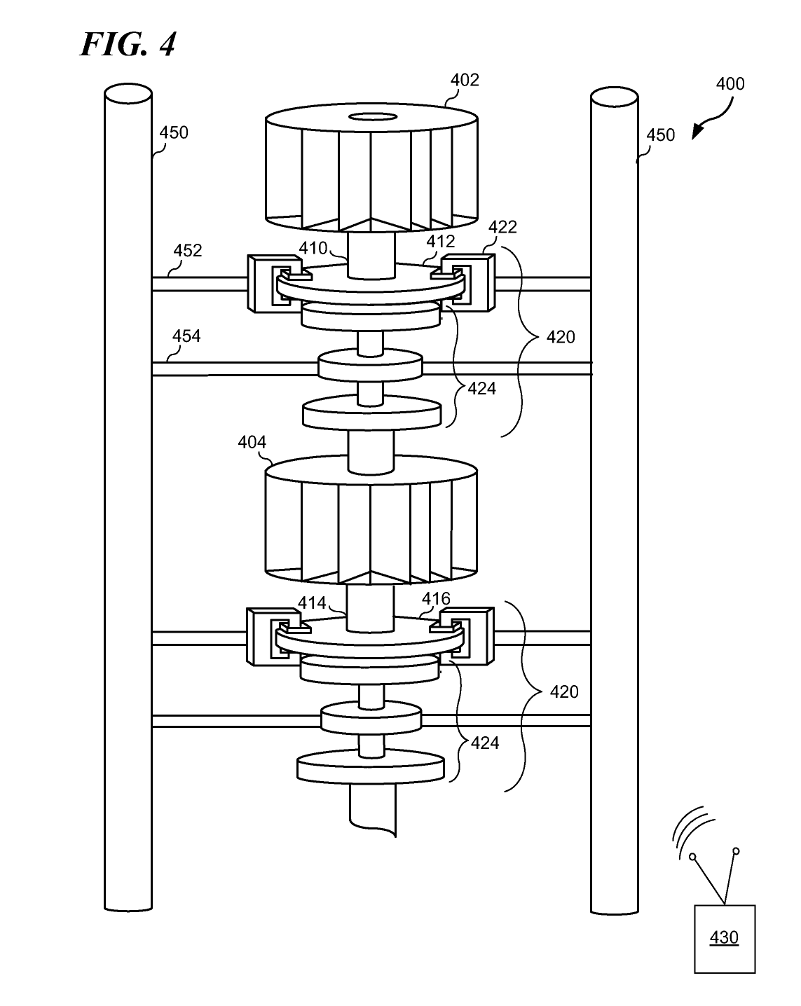

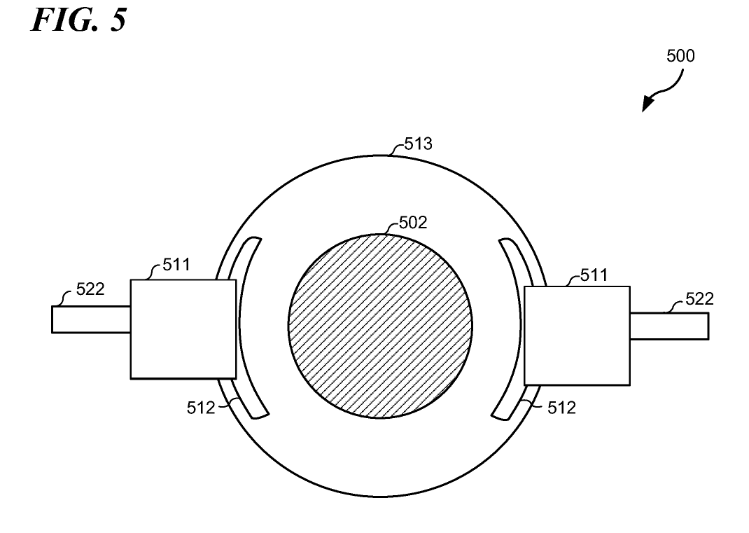

FIG. 4 provides a perspective representation illustrating exemplary elements in accordance with one embodiment;

FIG. 5 provides a top view representation illustrating exemplary elements in accordance with one embodiment;

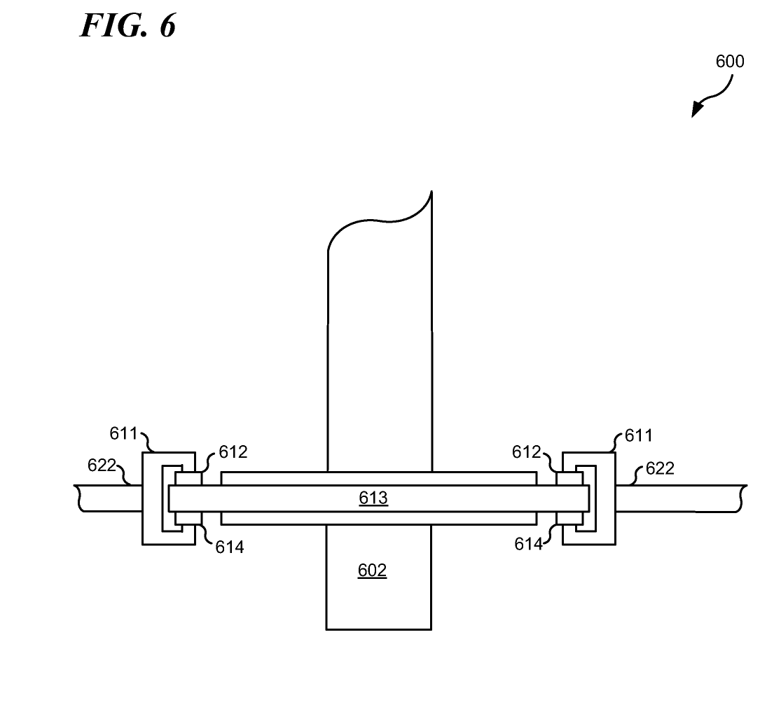

FIG. 6 provides a perspective representation illustrating exemplary elements in accordance with one embodiment;

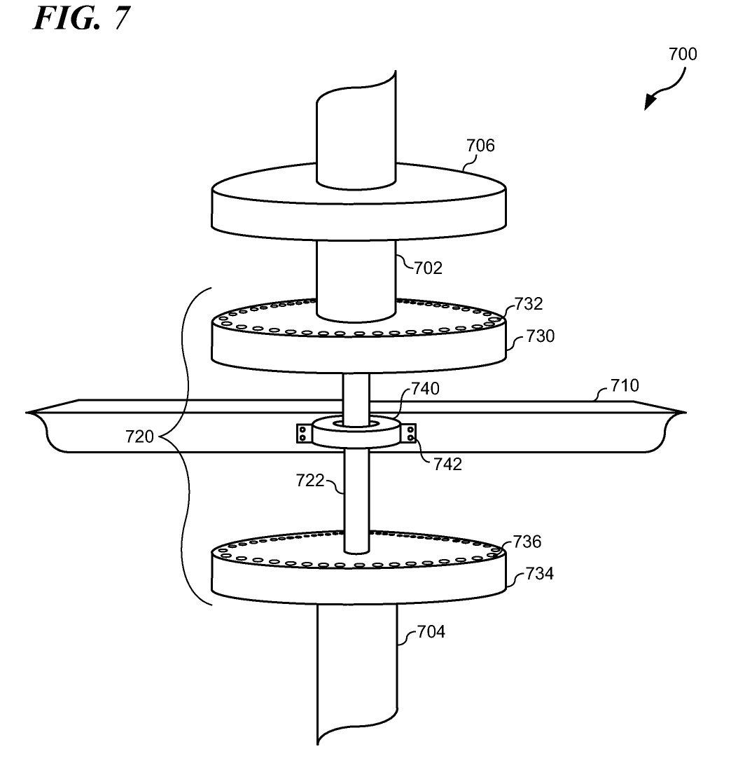

FIG. 7 provides a perspective representation illustrating exemplary elements in accordance with one embodiment;

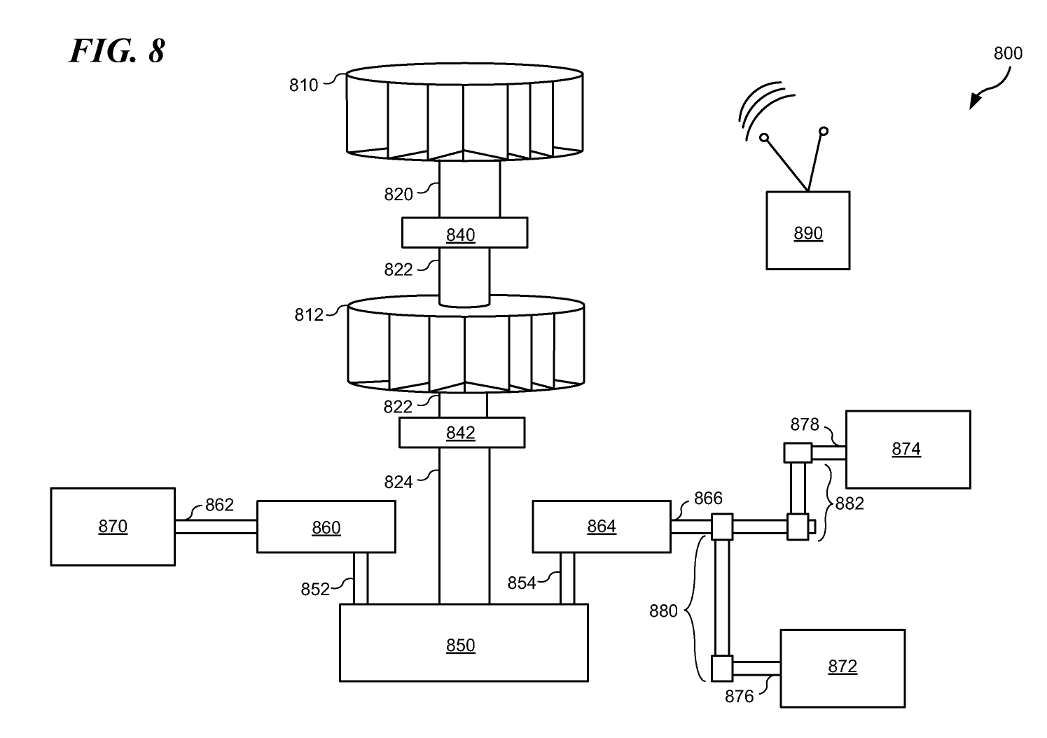

FIG. 8 provides a schematic representation illustrating exemplary elements in accordance with one embodiment;

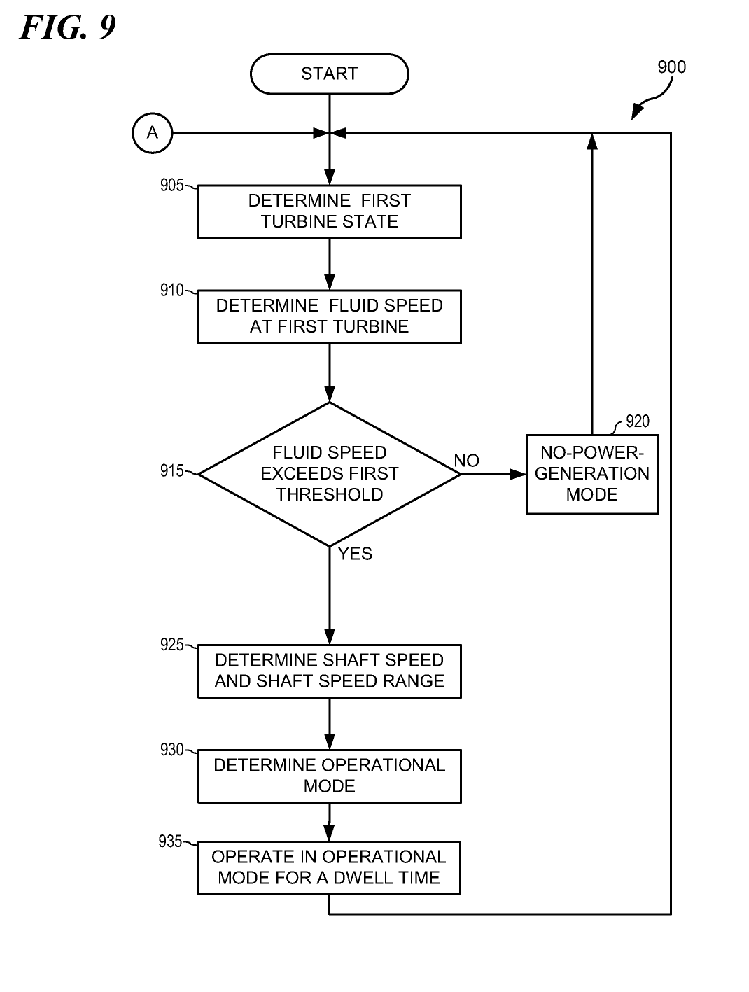

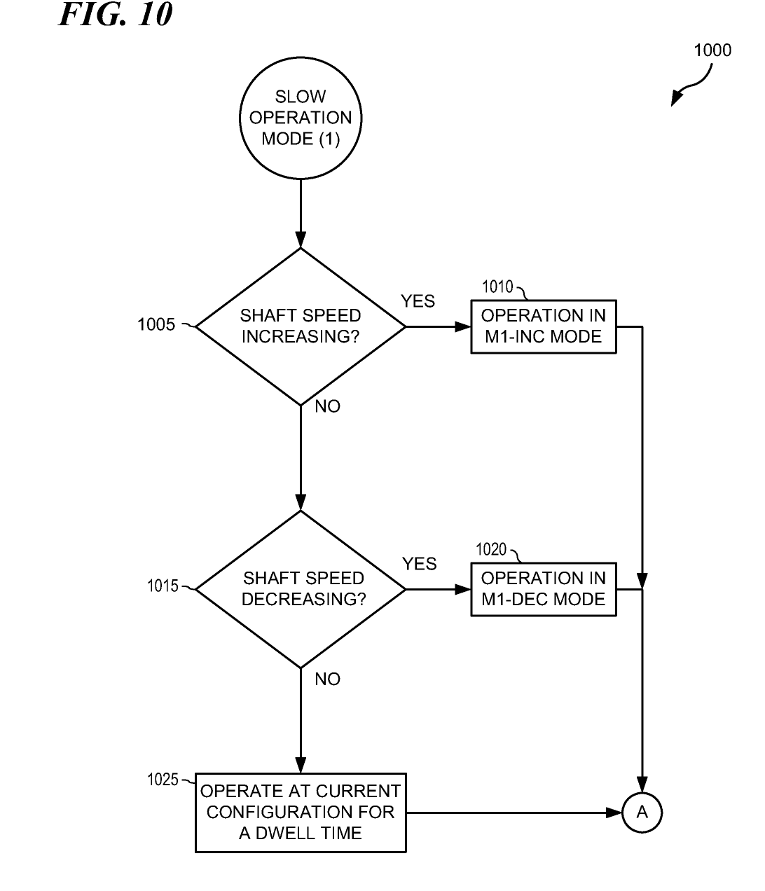

FIGS. 9-19 provide high-level flow charts illustrating operational steps of a method for energy transfer, which can be performed in accordance with an embodiment of the present invention;

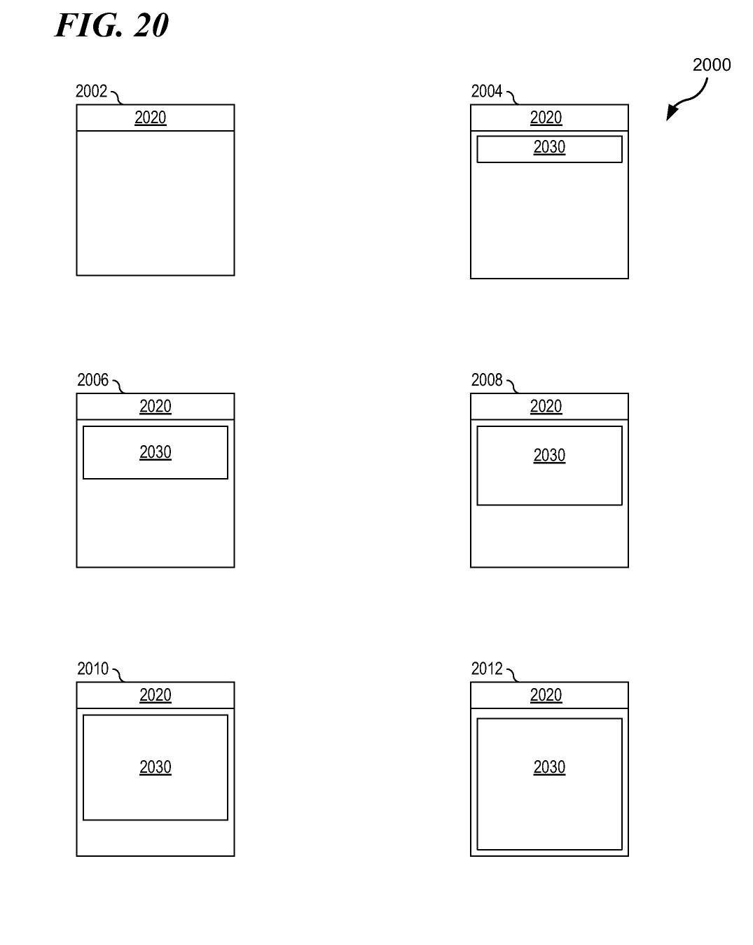

FIG. 20 provides a schematic representation illustrating exemplary elements in accordance with one embodiment; and

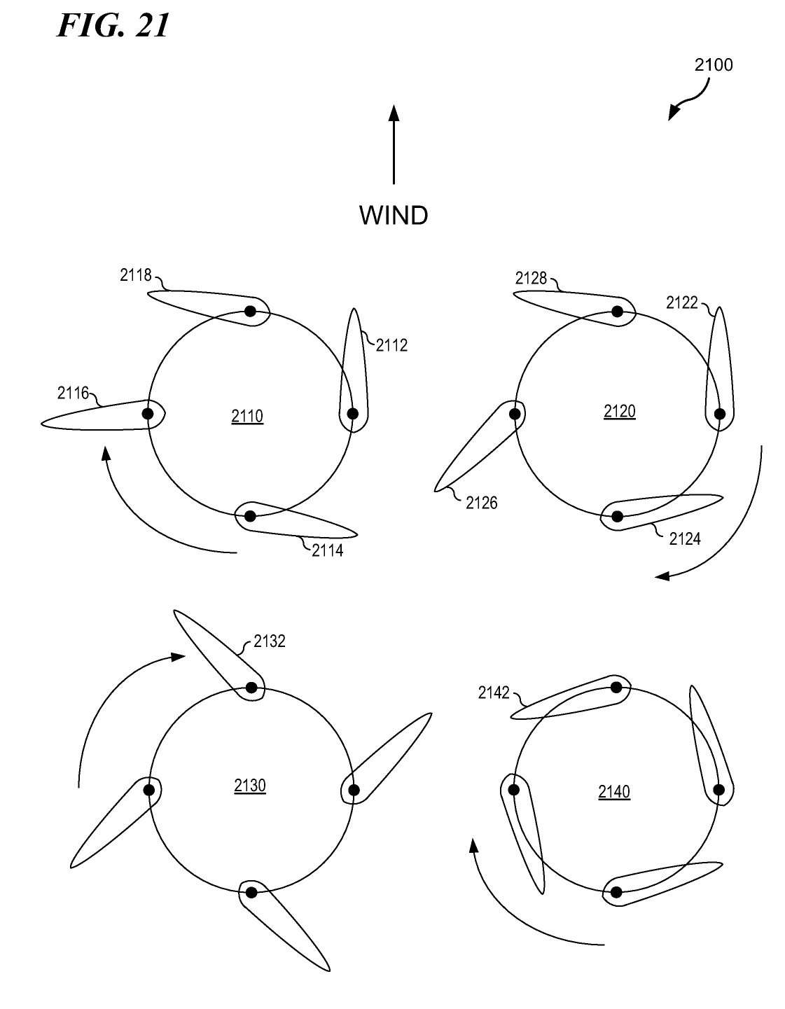

FIG. 21 provides a schematic representation illustrating exemplary elements in accordance with one embodiment.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

In one embodiment, a system comprises an enclosure comprising an interior, a drive shaft opening, and a first auxiliary drive shaft opening. A drive gear is disposed within the enclosure. A first auxiliary gear is disposed within the enclosure. The enclosure aligns the drive gear and the first auxiliary gear such that the drive gear is configured to drive the first auxiliary gear. The drive gear couples to an end of a drive shaft. The first auxiliary gear couples to a first end of a first auxiliary drive shaft. The drive shaft extends from the interior through the drive shaft opening. The first auxiliary drive shaft extends from the interior through the first auxiliary drive shaft opening.

In one embodiment, a system comprises a first drive shaft configured to rotate in response to rotation of a first turbine. A first braking disc couples to the first drive shaft. A first braking module couples to the first drive shaft, comprising a first braking pad, a second breaking pad, a first braking caliper, and a coupling module. The first braking caliper is configured to apply the first braking pad and the second braking pad to the braking first disc. The first coupling module is configured to couple the first drive shaft to a second drive shaft.

A method for fluid energy capture comprises monitoring an operational state of a first variable generator, the first variable generator configured to operate at a plurality of set points. A system monitors an operational state of a first fixed generator, the first fixed generator configured to operate at a single set point. The system monitors a shaft speed of a drive shaft. The drive shaft couples to a vertical turbine disposed in a fluid. The drive shaft is configured to rotate about an axis in response to rotation of the vertical turbine. The drive shaft further couples to the first variable generator and the first fixed generator. The system monitors a speed of the fluid. The system determines an operational mode based on the drive shaft speed and fluid speed. The system configures the operational state of the first variable generator and the first fixed generator based on the operational mode.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the disclosed embodiments. Those skilled in the art will appreciate that the disclosed embodiments may be practiced without such specific details. In other instances, well-known elements have been illustrated in schematic or block diagram form in order not to obscure the disclosed embodiments in unnecessary detail.

Referring now to the drawings, FIG. 1 illustrates a system 100 for improved fluid energy transfer. In the illustrated embodiment, system 100 includes an enclosure 110, a main drive shaft 121, a plurality of auxiliary drive shafts 122, a gearbox 130, and a generator shaft 131.

In the illustrated embodiment, enclosure 110 is an enclosure for containment of, among other things, additional elements of the disclosed embodiments as illustrated in FIGS. 2-3 and generally as described in more detail below. In addition, enclosure 110 further defines a drive shaft opening 112 and a plurality of auxiliary drive shaft openings 111. In the illustrated embodiment, drive shaft opening 112 defines an opening in enclosure 110 allowing drive shaft 121 to pass from the exterior of enclosure 110 into an interior 113 (FIGS. 2-3) of enclosure 110. Similarly, auxiliary drive shaft openings 111 define openings in enclosure 110 allowing auxiliary drive shafts 122 to pass from the exterior of enclosure 110 into interior 113 of enclosure 110.

In one embodiment, drive shaft 121 couples to a turbine such that rotational energy of the turbine transfers to drive shaft 121, causing drive shaft 121 to rotate in response to rotation of the turbine. As described in more detail below and illustrated in FIGS. 2-3, system 100 transfers the rotational energy of drive shaft 121 into rotational energy of auxiliary drive shafts 122.

In one embodiment, gearbox 130 couples to an auxiliary shaft 122, and a generator shaft 131 couples to gearbox 130. Generally, gearbox 130 transfers rotational energy of auxiliary drive shaft 122 to generator shaft 131. In one embodiment, generator shaft 131 further couples to a generator (not shown) directly or through a variable drive. In this manner, system 100 can be employed in a system to convert the rotational energy of auxiliary drive shafts 122 into electricity.

In the illustrated embodiment, system 100 includes one gearbox 130. In an alternate embodiment, system 100 includes a gearbox 130 for each auxiliary drive shaft 122. One skilled in the art will understand that the disclosed embodiments contemplate and include any appropriate mechanism to transfer the rotational energy of auxiliary drives shafts 122 to devices coupled to auxiliary drive shafts 122. For example, appropriate mechanisms include, but are not limited to, variable speed drives, belt drives, and other suitable mechanisms. In the illustrated embodiment, gearbox 130 is one such mechanism.

FIG. 2 provides a sectional view of system 100 of FIG. 1 taken along line 2-2 of FIG. 1. In the illustrated embodiment, a drive gear 151 couples to drive shaft 121 within enclosure 110. In one embodiment, drive gear 151 comprises a helical gear. One skilled in the art will understand that the disclosed embodiments contemplate and include alternative configurations for drive gear 151, including toothed gears and other suitable configurations.

Similarly, auxiliary drive shafts 122 couple to auxiliary gears 141 within enclosure 110. In one embodiment, auxiliary gears 141 comprise helical gears. One skilled in the art will understand that the disclosed embodiments contemplate and include alternative auxiliary gears 141 configured to mesh with, and be driven by, drive gear 151. In one embodiment, enclosure 110 is configured with one auxiliary gear 141. In an alternate embodiment, enclosure 110 is configured with a plurality of auxiliary gears 141. In one embodiment, four auxiliary gears 141 couple to drive gear 151.

In the illustrated embodiment, drive gear 151 and auxiliary gears 141 mesh in a parallel orientation providing a line of contact that increases the strength of the interaction between drive gear 151 and auxiliary gears 141. In one embodiment, the gear ratio between auxiliary gears 141 and drive gear 151 is a gear ratio of about 6:1 or about 7:1. Thus, generally, drive gear 151 transmits the rotational energy of drive shaft 121 to auxiliary shafts 122. One skilled in the art will understand that the disclosed embodiments contemplate and include additional auxiliary gears 141 and/or additional auxiliary drive shafts 122. The selection of exemplary elements illustrated in FIG. 2 are intended for ease of explanation and not to otherwise limit the scope of the disclosed embodiments.

In the illustrated embodiment, enclosure 110 defines an interior 113. In one embodiment a lubricant, such as oil, for example, can fill interior 113 and envelop drive gear 151, drive shaft 121, auxiliary gears 141, and auxiliary shafts 122. In one embodiment, interior 113 does not align drive gear 151 and auxiliary gears 141. In an alternate embodiment, interior 113 also includes an alignment framework configured to align drive gear 151 and auxiliary gears 141. One skilled in the art will understand that the disclosed embodiments contemplate and include wide variation in the configuration of interior 113 such that interior 113 performs the dual function of containing a lubricant and aligning drive gear 151 with auxiliary gears 141.

FIG. 3 provides a sectional view of system 100 of FIG. 1 taken along line 3-3 of FIG. 1. In the illustrated embodiment, system 100 includes one or more bearings. For example, in the illustrated embodiment, system 100 includes a drive shaft bearing 152 and one or more auxiliary bearings 142. Generally, drive shaft bearing 152 couples to drive shaft 121 and supports drive shaft 121 such that drive shaft 121 rotates about its axis within enclosure 110. Generally, an auxiliary bearing 142 couples to an auxiliary drive shaft 122 and supports that auxiliary drive shaft 122 such that auxiliary drive shaft 122 rotates about its axis within enclosure 110. In one embodiment, drive shaft bearing 152 couples to an end of drive shaft 121, and auxiliary bearing 142 couples to an end of auxiliary drive shaft 122. One skilled in the art will understand that the disclosed embodiments contemplate and include couplings of drive shaft bearings 152 in any suitable manner such that drive shaft 121 rotates within enclosure 110. Similarly, one skilled in the art will understand that the disclosed embodiments contemplate and include couplings of auxiliary bearings 142 in any suitable manner such that auxiliary drive shafts 122 rotate within enclosure 110.

In an exemplary operation of system 100 in one embodiment, a turbine coupled to drive shaft 121 causes drive shaft 121 to rotate about its axis. Rotation of drive shaft 121 rotates drive gear 151. Drive gear 151 meshes with auxiliary gears 141 such that the rotation of drive gear 151 transmits rotational energy to auxiliary gears 141. Each auxiliary gear 141 causes the associated coupled auxiliary drive shaft 122 to rotate. In turn, rotation of each auxiliary drive shaft 122 causes an associated coupled gearbox 130 to operate. As each associated coupled gearbox 130 operates, the gearbox 130 rotates its associated generator shaft 131.

So configured, auxiliary drive shafts 122 transmit rotational energy to a generator coupled to generator shaft 131, the generator converting the rotational energy within system 100 into electricity. Thus, in one embodiment, system 100 can be configured to generate electricity from a turbine and drive shaft rotating as slowly as about 10-12 revolutions per minute (rpm) up to about 1800 rpm. Furthermore, as described in more detail below, system 100 can be configured to operate efficiently when the captured fluid includes water or air with little to no reconfiguration. In addition, some embodiments of system 100 include a torque limiter engaged to limit the rotation of a turbine coupled to system 100 to below a predetermined threshold.

In one embodiment, four auxiliary drive shafts 122 operate a plurality of generators coupled to the auxiliary drive shafts 122 by variable speed drives (not shown). As described in more detail below, the variable speed drives can be configured to allow system 100 to maintain a constant speed at the generator the generator despite variation in wind speed. In addition, in one embodiment, system 100 includes electronic clutches configured to engage the generators according to the method described below with respect to FIGS. 9-19, allowing efficient electricity production across wide variations in wind speed, turbine rotation speed, and drive shaft rotation speed.

Systems employing system 100 can also be configured for additional improved performance through improved braking. For example, FIG. 4 illustrates a system 400 for improved turbine braking. System 400 includes a first turbine 402 and a second turbine 404. Generally, each turbine 402 and 404 couples to a turbine shaft and transfers rotational energy to its associated shaft. For example, turbine 402 couples to turbine shaft 410 and turbine 404 couples to turbine shaft 414. Shaft 410 rotates in response to the rotation of turbine 402 and shaft 414 rotates in response to the rotation of turbine 404. Generally, shaft 410 and shaft 414 couple to a main drive shaft 406 as described in more detail below.

System 400 also includes a plurality of braking modules 420. In the illustrated embodiment, each braking module 420 is configured to slow and/or stop the rotation of an associated turbine shaft. In one embodiment, each braking module 420 is configured to exert sufficient force on its associated shaft such that each braking module 420 can slow and/or stop its associated shaft, and therefore the shafts to which the associated shaft couples, independently of additional braking modules 420. In an alternate embodiment, each braking module 420 is configured to slow and/or stop its associated shaft in cooperation with additional braking modules 420.

In one embodiment, each braking module includes a plurality of brakes 422, described in additional detail below. In the illustrated embodiment, each braking module 420 also includes a coupling 424, described in more detail below. Generally, each coupling 424 is configured to couple together two shafts. For example, as illustrated, a coupling 424 couples shaft 410 to shaft 414, and a coupling 424 couples shaft 414 to shaft 406. Exemplary embodiments of braking module 420 are described in more detail below with respect to FIGS. 5-7.

In the illustrated embodiment, system 400 includes a segmented shaft, configured with drive shaft 406, turbine shaft 410, and turbine shaft 412. In an alternate embodiment, system 400 includes a single contiguous drive shaft, to which each turbine 402 and 404 couple.

One skilled in the art will understand that vertical turbine systems frequently employ a framework structure to support and elevate various components of the vertical turbine system. For example, system 400 includes support poles 450 and support beams 452 and 454. Generally, as shown, support poles 221 and support beams 452 and 454 provide an anchorage and mount point for the components of braking modules 420. One skilled in the art will understand that other configurations can also be employed to anchor braking module 420.

System 400 also includes a braking control module 430. Braking control module 430 includes a control system communicatively coupled to each braking module 420 such that braking control module 430 can activate or deactivate braking module 420. In one embodiment, control module 430 is configured to control brakes 422. In an alternative embodiment, control module 430 is configured to communicate control signals to braking module 420, and braking module 420 is configured to control brakes 422 in response to received control signals.

FIG. 5 illustrates an exemplary braking module 500 in a top view, in one embodiment. In particular, in the illustrated embodiment, braking module 500 includes braking calipers 511, first braking pads 512, a braking disc 513, and a shaft 502. Generally, braking disc 513 rotates with shaft 502. In the illustrated embodiment, braking calipers 511 couple to a mount point (not shown) through mounts 522. In the illustrated embodiment, braking calipers 511 are configured to press or otherwise apply braking pads 512 against the rotating disc 513, increasing friction and drag on disc 513. The increased friction and drag causes disc 513 to slow, and eventually halt, its rotation, which also causes shaft 502 to halt.

FIG. 6 illustrates an exemplary braking module 600 in a side view, in one embodiment. In particular, in the illustrated embodiment, braking module 600 includes braking calipers 611, first braking pads 612, second braking pads 614, a braking disc 613, and a shaft 602. Generally, braking disc 613 rotates with shaft 602. In the illustrated embodiment, braking calipers 611 couple to a mount point (not shown) through mounts 622. In the illustrated embodiment, braking calipers 611 are configured to press or otherwise apply braking pads 612 and 614 against the rotating disc 613, increasing friction and drag on disc 613. The increased friction and drag causes disc 613 to slow, and eventually halt, its rotation, which also causes shaft 602 to halt.

FIG. 7 illustrates an exemplary coupling system 700, in one embodiment. Generally, a coupling 720 couples to a support beam 710. In the illustrated embodiment, coupling 720 is configured to couple turbine shaft 702 to turbine shaft 704. In the illustrated embodiment, coupling 720 is disposed below the braking disc 706 of shaft 702. In an alternate embodiment, coupling 720 can be configured to include braking mechanisms that are configured to couple to disc 706.

In the illustrated embodiment, coupling 720 includes coupling shaft 722. Generally, shaft 722 is configured to rotate with shafts 702 and 704. In one embodiment, shaft 722 is configured to sustain loads comparable to the loads sustained by shafts 702 and 704.

Shaft 722 couples to a connection plate 730. Shaft 702 also couples to connection plate 730. In the illustrated embodiment, connection plate 730 includes a plurality of fasteners 732 configured to couple shaft 722 to shaft 702. Similarly, shaft 722 couples to a connection plate 734. Shaft 704 also couples to connection plate 734. In the illustrated embodiment, connection plate 734 includes a plurality of fasteners 736 configured to couple shaft 722 to shaft 704.

In the illustrated embodiment braking disc 706 is shown set apart from connection plate 730. In an alternate embodiment, connection plate 730 operates as braking disc 706. In an alternate embodiment, connection plate 730 couples flush against braking disc 706, and is configured with a smaller diameter than disc 706.

Coupling 720 includes a bearing 740. Generally, bearing 740 includes fasteners 742 configured to couple bearing 740 to support beam 710. In the illustrated embodiment, bearing 730 is configured to receive and support coupling shaft 722 such that shaft 722 retains freedom of rotation within bearing 742.

FIG. 8 illustrates an exemplary power system 800 in accordance with one embodiment. In the illustrated embodiment, system 800 includes a first turbine 810 and a second turbine 812. First turbine 810 is an otherwise conventional turbine and couples to turbine shaft 820.

In the illustrated embodiment, shaft 820 couples to braking module 840. In one embodiment, braking module 840 is a braking module as described above, such as braking module 600 of FIG. 6, for example. Braking module 840 couples to turbine shaft 822.

In the illustrated embodiment, shaft 822 couples to second turbine 812. Second turbine 812 is an otherwise conventional turbine. In the illustrated embodiment, shaft 822 also couples to braking module 842. In one embodiment, braking module 842 is a braking module as described above, such as braking module 600 of FIG. 6, for example. Braking module 842 couples to drive shaft 824.

In the illustrated embodiment, drive shaft 824 couples to a bearing assembly 850. In one embodiment, assembly 850 is configured as system 100, described above in FIGS. 1-3. In the illustrated embodiment, assembly 850 includes auxiliary drive shaft 852.

In the illustrated embodiment, shaft 852 couples to a gearbox 860. In one embodiment, gearbox 860 is an otherwise conventional gearbox and is configured to translate rotational energy received from shaft 852 into rotational energy applied to a generator shaft 862. In the illustrated embodiment, generator shaft 862 couples to a generator 870 and is configured to provide rotational energy to generator 870. In one embodiment, generator 870 is an otherwise conventional generator and is configured to convert received rotational energy into electrical energy. In one embodiment, generator 870 is configured to operate at a single operating speed, as described in more detail below.

In the illustrated embodiment, assembly 850 includes auxiliary drive shaft 854. In the illustrated embodiment, shaft 854 couples to a gearbox 864. In one embodiment, gearbox 864 is an otherwise conventional gearbox and is configured to translate rotational energy received from shaft 854 into rotational energy applied to a generator shaft 866. In the illustrated embodiment, generator shaft 866 couples to variable drive 880 and variable drive 882.

Generally, variable drive 880 is an otherwise conventional variable drive and is configured to translate rotational energy received from shaft 866 into rotational energy applied to a generator shaft 876. In the illustrated embodiment, generator shaft 876 couples to a generator 872 and is configured to provide rotational energy to generator 872. In one embodiment, generator 872 is an otherwise conventional generator and is configured to convert received rotational energy into electrical energy. In one embodiment, generator 872 is configured to operate at varying operating speeds, as described in more detail below.

Generally, variable drive 882 is an otherwise conventional variable drive and is configured to translate rotational energy received from shaft 866 into rotational energy applied to a generator shaft 878. In the illustrated embodiment, generator shaft 878 couples to a generator 874 and is configured to provide rotational energy to generator 874. In one embodiment, generator 874 is an otherwise conventional generator and is configured to convert received rotational energy into electrical energy. In one embodiment, generator 874 is configured to operate at varying operating speeds, as described in more detail below.

System 800 also includes a control module 890. In one embodiment, control module 890 is communicatively coupled to one or more elements of system 800 such that control module 890 engages and/or disengages various elements of system 800. In the illustrated embodiment, control module 890 is configured to transmit and receive wireless signals to and from one or more elements of system 800. In an alternate embodiment, control module 890 is configured to couple to one or more elements through a wire, fiber optic cable, or other suitable physical connection. Generally, system 800 is configured to receive wind energy and convert received wind energy to electrical energy. For example, in one embodiment, system 800 is configured as described below with respect to FIGS. 9-19.

Generally, FIGS. 9-19 describe a configuration for a wind energy capture system in accordance with one embodiment. For ease of explanation, FIGS. 9-19 are described with respect to a specific configuration of components in an exemplary system. As such, the embodiment described in FIGS. 9-19 is not intended to be exhaustive. One skilled in the art will understand that certain modifications to the methods disclosed in FIGS. 9-19 can be made based on the particular system configuration of the system in which the embodiment is employed. For ease of explanation, FIGS. 9-19 are described with respect to an exemplary system such as, for example, system 800 of FIG. 8.

Generally, in one embodiment, the target capacity of a vertical turbine 810 is 250 kW (kilowatts). In one embodiment, system 800 achieves the target capacity through multiple generators of smaller capacity, which helps reduce costs and assists in capturing energy from slower wind speeds. Further, in one embodiment, system 800 includes variable drives 880 and 882, which can be configured to increase generator capacity for a wider range of wind speeds.

For example, in one embodiment, system 800 can be configured to capture sufficient energy to operate smaller capacity generators. In one embodiment, a variable speed drive allows electrical generation at turbine speeds as low as 2.9 revolutions per minute (rpm). In one embodiment, as the turbine speed increases, the variable speed drive adjusts the generator speed to maintain acceptable speeds.

Generally, in one embodiment, the control system is configured to maximize power generation for a given wind speed. In one embodiment, based on the physical size of the vertical turbine, system 800 achieves full-speed operation with a main shaft (such as shaft 824, for example) speed of 10 rpm when the wind speed is at or above 15 miles per hour (mph).

In one embodiment, system 800 is configured with three variable generators, such as generators 872 or 874, for example, and two fixed generators, such as generator 870, for example. Generally, a “variable generator” is an otherwise conventional generator configured to operate at a plurality of “set points”. Generally, in one embodiment, a set point is a predetermined generator shaft rpm. Generally, a “fixed generator” is an otherwise conventional generator configured to operate at a single set point, or a reduced number of set points.

Generally, both variable generators and fixed generators can be configured to be energized and de-energized. In one embodiment, a generator is “energized” when it is running and the generator shaft clutch is engaged. In one embodiment, a generator is “de-energized” when the generator shaft clutch is disengaged.

In one embodiment, system 800 is configured as described in Table 1, below. For clarity of explanation, the remainder of the discussion of FIGS. 9-19 will refer to this non-exclusive embodiment.

TABLE 1

| | Rated | Drive | |
|---|---|---|---|
| Name | Power | Type | Generator Speed Set Points (SP) |
| Generator 1 (G1) | 19 kW | Variable | 1815, 1830, 1848, 1865, 1882 |
| Generator 2 (G2) | 35 kW | Variable | 1810, 1820, 1830, 1840, 1855 |
| Generator 3 (G3) | 57 kW | Variable | 1817, 1825, 1838, 1848, 1858 |
| Generator 4 (G4) | 57 kW | Fixed | 1848 |
| Generator 5 (G5) | 57 kW | Fixed | 1848 |

Based on maximum drive train ratios, both G1 and G2 can be engaged at a main shaft speed as low as 2.9 rpm. In the illustrated embodiment, a main shaft speed of 2.9 rpm corresponds to a wind speed of approximately 4.3 mph (1.9 meters/second (m/s)). Generally, system 800 engages the generators based on the shaft speed, wind speed, and other suitable operational conditions. For example, when the shaft speed increases to 5.0 rpm, system 800 engages G3. When the shaft speed is at or above 9.7 rpm, system 800 engages G4 and G5. G5 couples directly to the main shaft.

Generally, as described in more detail below, at low wind speeds where the main shaft speed is less than 10 mph, system 800 gradually increases the generator load until the shaft speed begins to slow. When the shaft speed begins to slow, system 800 reduces generator power slightly for steady-state operations. As the wind speed increases, the main shaft speed increases up to the rated speed.

When the main shaft speed reaches the rated speed, any incremental increase in shaft speed results in the addition of generation power to add load to the shaft. As long as the shaft speed does not decrease, additional power is added. The variable speed drives allow for fine tuning. If system 800 detects a reduction in shaft speed, some generation power is removed.

For higher wind speeds, the rotor speed may continue increasing even with all generators at capacity. In that case, system 800 executes a series of operations to reduce the generating capacity of the turbine. First, in systems configured with radial (wind-focusing) vanes, described in more detail below, some of the radial vanes are closed, or partially closed. Second, in systems configured with turbine carousels configured to restrict the movement of the turbine blades, system 800 begins to reconfigure the carousels to restrict blade wind capture, described in more detail below. Completely retracting the radial vanes and closing the carousels reduces wind capture to a minimum.

At minimum wind capture, system 800 can still generate power. However, extreme wind speeds (at or above 70 mph) can cause damage to system 800. As such, at extreme wind speeds, system 800 applies dynamic brakes (such as braking modules 840 and 842) to reduce or halt shaft rotation.

Thus, generally, system 800 can be configured to adjust operational states of various system components based on dynamic operational conditions such as wind speed, shaft speed, and other conditions. FIGS. 9-19 illustrate an exemplary response configuration for system 800.

FIG. 9 illustrates a high-level flow chart 900 that depicts logical operational steps performed by, for example, system 800 of FIG. 8, which can be implemented in accordance with a preferred embodiment. The process begins at block 905, wherein the system determines an operational state of a first turbine. In one embodiment, a turbine operational state includes the turbine's rotational speed and the state of the turbine carousel. Next, as indicated at block 910, the system determines a fluid speed at the first turbine. For example, system 800 measures the wind speed at or near turbine 810.

Next, as indicated at decisional block 915, the system determines whether the fluid speed exceeds a first threshold. For example, system 800 determines whether the wind speed is greater than 4.5 mph. If at decisional block 915 the system determines that the fluid speed does not exceed the first threshold, the process continues along the NO branch to block 920. As indicated at block 920, the system operates in a no-power-generation mode and the process returns to block 905.

In one embodiment, system 800 operates in a no-power-generation mode (mode 0) for a predetermined dwell time. In one embodiment, system 800 is configured in mode 0 when the turbine blades are configured for full articulation, the main shaft brake is off, the generators (G1 through G5) are de-energized, and all radial vanes are configured in position 5 (fully extended).

If at decisional block 915 the system determines that the fluid speed does exceed the first threshold, the process continues along the YES branch to block 925. As indicated at block 925, the system determines the shaft speed of the main shaft, and the shaft speed range. In one embodiment, the shaft speed range includes a determination whether the shaft speed is increasing, decreasing, or remaining constant (within a certain degree of tolerance).

Next, as indicated at block 930, the system determines an operational mode based on the first turbine state, the determined fluid speed, the shaft speed, and the shaft speed range. For example, system 800 selects from among a slow operation mode “mode (1)”, a standard operation mode “mode (2)”, a high wind-speed operation mode “mode (3)”, and a shutdown mode “mode (10)” based on the first turbine state, the wind speed, the shaft speed, and the shaft speed range. System 800 selects mode (1) if the shaft speed is between 2.9 rpm and 10.0 rpm. System 800 selects mode (2) if the shaft speed is approximately 10.1 rpm. System 800 selects mode (3) if the shaft speed is between 10.1 rpm and 10.2 rpm and the wind speed is less than or equal to 65 mph. System 800 selects mode (10) if the shaft speed is between 10.1 rpm and 10.2 rpm and the wind speed is greater than 65 mph.

Next, as indicated at block 935, the system operates in the determined operational mode for a dwell time, returning to block 905. In one embodiment, the dwell time is 5 minutes. If system 800 selects mode (1), system 800 extends the radial vanes to position 5 (fully extended) and configures the carousel for full articulation (configuration “A”). If system 800 selects mode (3), system 800 retracts the radial vanes to position 0 (fully retracted). If system 800 selects mode (10), system 800 retracts the radial vanes to position 0 (fully retracted) and configures the carousel in the closed position (configuration “D”).

FIG. 10 illustrates a high-level flow chart 1000 that depicts logical operational steps performed by, for example, system 800 of FIG. 8 in mode (1) (slow), which can be implemented in accordance with a preferred embodiment. The process begins at decisional block 1005, wherein the system determines whether the shaft speed is increasing. In one embodiment, system 800 determines whether the shaft speed is increasing based on the shaft speed range as described above.

If at block 1005 the shaft speed is increasing, the process continues along the YES branch to block 1010. As indicated at block 1010, the system operates in “M1-INC” mode (described in more detail below) and the process returns to marker A of FIG. 9. If at block 1005 the shaft speed is not increasing, the process continues along the NO branch to decisional block 1015.

As indicated at decisional block 1015, the system determines whether the shaft speed is decreasing. In one embodiment, system 800 determines whether the shaft speed is decreasing based on the shaft speed range as described above. If at block 1015 the shaft speed is decreasing, the process continues along the YES branch to block 1020. As indicated at block 1020, the system operates in “M1-DEC” mode (described in more detail below) and the process returns to marker A of FIG. 9. If at block 1015 the shaft speed is not decreasing, the process continues along the NO branch to decisional block 1025.

Next, as indicated at block 1025, the system operates in its current configuration for a dwell time, and the process returns to marker A of FIG. 9. In one embodiment, system 800 generates power up to 111 kW in mode (1). In one embodiment, the dwell time is 5 minutes.

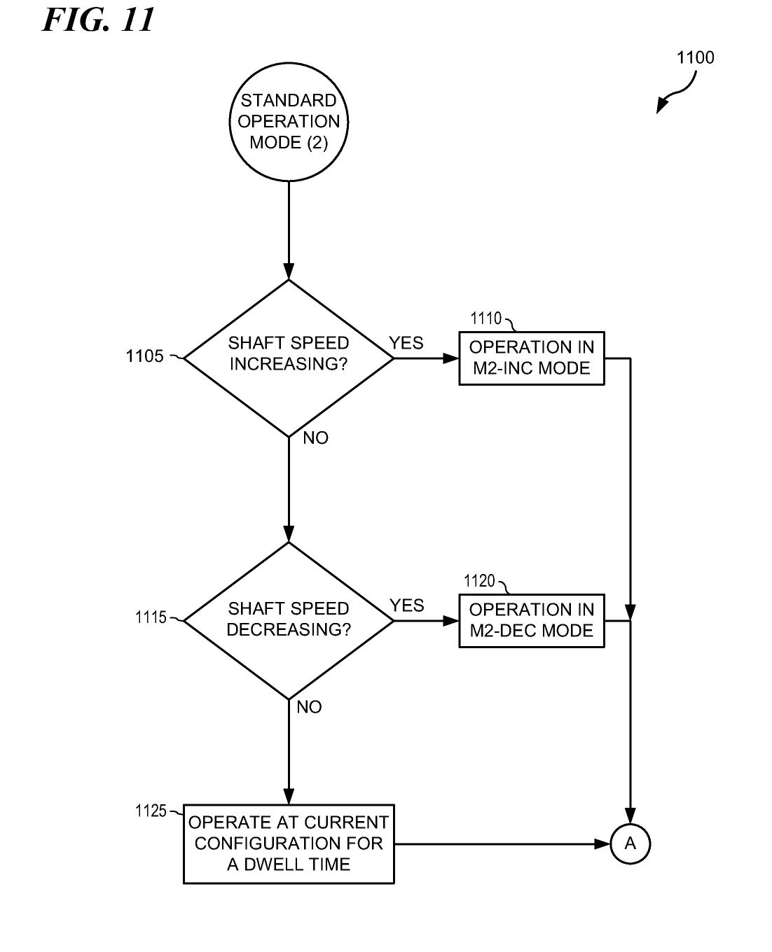

FIG. 11 illustrates a high-level flow chart 1100 that depicts logical operational steps performed by, for example, system 800 of FIG. 8 in mode (2) (standard), which can be implemented in accordance with a preferred embodiment. The process begins at decisional block 1105, wherein the system determines whether the shaft speed is increasing. In one embodiment, system 800 determines whether the shaft speed is increasing based on the shaft speed range as described above.

If at block 1105 the shaft speed is increasing, the process continues along the YES branch to block 1110. As indicated at block 1110, the system operates in “M1-INC” mode (described in more detail below) and the process returns to marker A of FIG. 9. If at block 1105 the shaft speed is not increasing, the process continues along the NO branch to decisional block 1115.

As indicated at decisional block 1115, the system determines whether the shaft speed is decreasing. In one embodiment, system 800 determines whether the shaft speed is decreasing based on the shaft speed range as described above. If at block 1115 the shaft speed is decreasing, the process continues along the YES branch to block 1120. As indicated at block 1120, the system operates in “M1-DEC” mode (described in more detail below) and the process returns to marker A of FIG. 9. If at block 1115 the shaft speed is not decreasing, the process continues along the NO branch to decisional block 1125.

Next, as indicated at block 1125, the system operates in its current configuration for a dwell time, and the process returns to marker A of FIG. 9. In one embodiment, system 800 generates power up to 225 kW in mode (2) without requiring modifications to the carousel configurations to reduce wind capture. In one embodiment, the dwell time is 5 minutes.

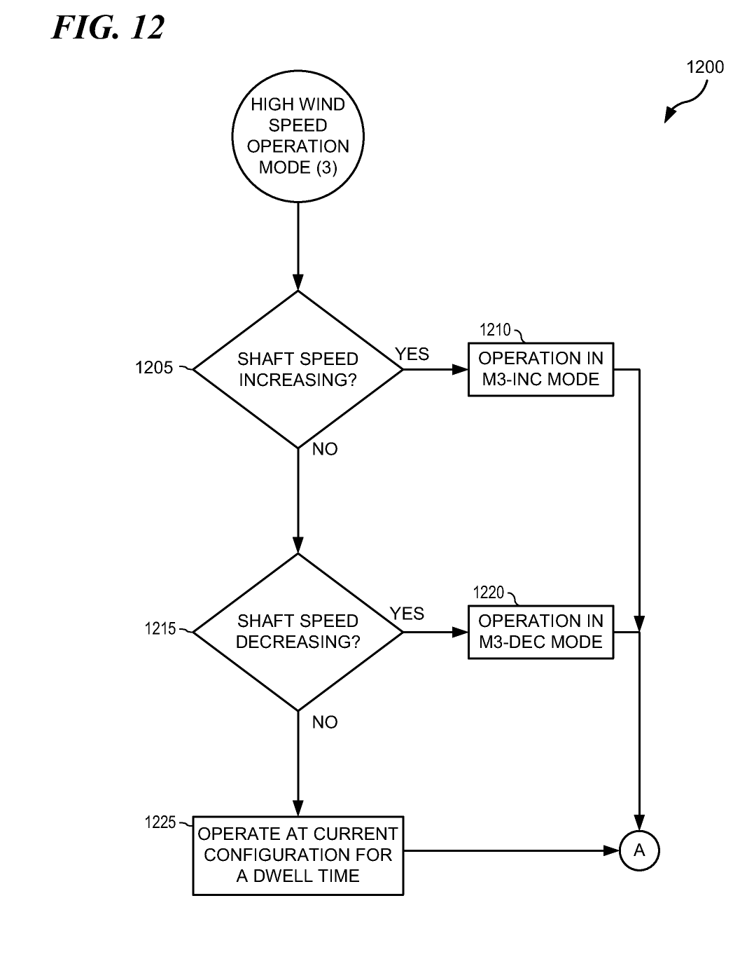

FIG. 12 illustrates a high-level flow chart 1200 that depicts logical operational steps performed by, for example, system 800 of FIG. 8 in mode (3) (high wind speed), which can be implemented in accordance with a preferred embodiment. The process begins at decisional block 1205, wherein the system determines whether the shaft speed is increasing. In one embodiment, system 800 determines whether the shaft speed is increasing based on the shaft speed range as described above.

If at block 1205 the shaft speed is increasing, the process continues along the YES branch to block 1210. As indicated at block 1210, the system operates in “M1-INC” mode (described in more detail below) and the process returns to marker A of FIG. 9. If at block 1205 the shaft speed is not increasing, the process continues along the NO branch to decisional block 1215.

As indicated at decisional block 1215, the system determines whether the shaft speed is decreasing. In one embodiment, system 800 determines whether the shaft speed is decreasing based on the shaft speed range as described above. If at block 1215 the shaft speed is decreasing, the process continues along the YES branch to block 1220. As indicated at block 1220, the system operates in “M1 -DEC” mode (described in more detail below) and the process returns to marker A of FIG. 9. If at block 1215 the shaft speed is not decreasing, the process continues along the NO branch to decisional block 1225.

Next, as indicated at block 1225, the system operates in its current configuration for a dwell time, and the process returns to marker A of FIG. 9. In one embodiment, system 800 generates power up to 225 kW in mode (3) and retracts the radial vanes to position 0 (fully retracts) without requiring modifications to the carousel configurations to reduce wind capture. In one embodiment, the dwell time is 5 minutes.

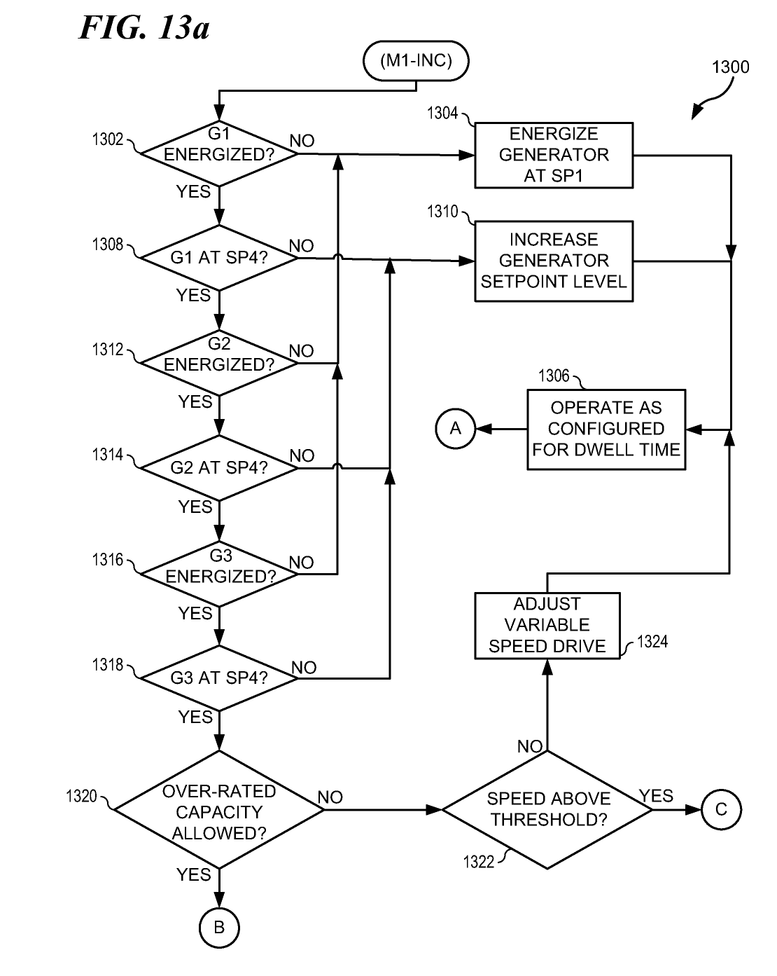

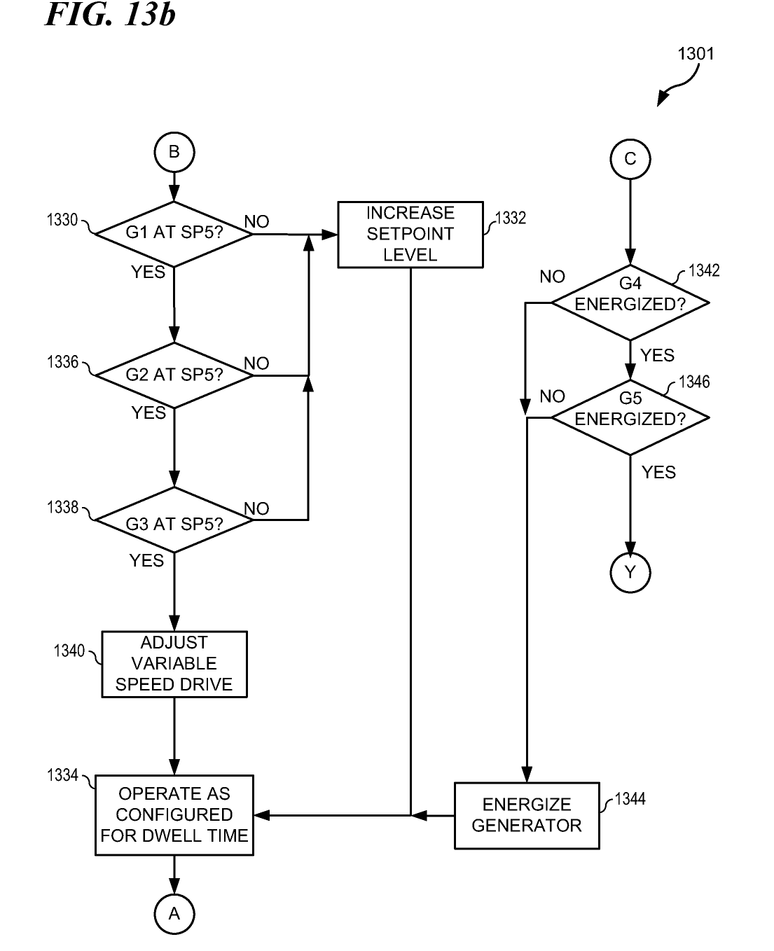

FIG. 13a illustrates a high-level flow chart 1300 that depicts logical operational steps performed by, for example, system 800 of FIG. 8 in mode (1) “M1-INC” (mode (1), shaft speed INCreasing), which can be implemented in accordance with a preferred embodiment. The process begins at decisional block 1302, wherein the system determines whether generator G1 is energized. If at decisional block 1302 G1 is not energized, the process continues along the NO branch to block 1304.

As indicated at block 1304, the system energizes G1 at its lowest set point, SP1. Next, as indicated at block 1306, the system operates as configured for a dwell time. In one embodiment, the dwell time is 5 minutes. The process returns to marker A of FIG. 9.

If at decisional block 1302 G1 is energized, the process continues along the YES branch to decisional block 1308. As indicated at decisional block 1308, the system determines whether G1 is at SP4.

If at decisional block 1308 G1 is not at SP4, the process continues along the NO branch to block 1310. As indicated at block 1310, the system increases G1's set point by one level, to SP5. The process continues to block 1306 as described above.

If at decisional block 1308 G1 is at SP4, the process continues along the YES branch to decisional block 1312. As indicated at decisional block 1312, the system determines whether G2 is energized.

If at decisional block 1312 G2 is not energized, the process continues along the NO branch to block 1304, wherein G2 is energized at SP1. The process continues to block 1306 as described above.

If at decisional block 1312 G2 is energized, the process continues along the YES branch to decisional block 1314. As indicated at decisional block 1314, the system determines whether G2 is at SP4.

If at decisional block 1314 G2 is not at SP4, the process continues along the NO branch to block 1310. As indicated at block 1310, the system increases G2's set point by one level, to SP5. The process continues to block 1306 as described above.

If at decisional block 1314 G2 is at SP4, the process continues along the YES branch to decisional block 1316. As indicated at decisional block 1316, the system determines whether G3 is energized.

If at decisional block 1316 G3 is not energized, the process continues along the NO branch to block 1304, wherein G3 is energized at SP1. The process continues to block 1306 as described above.

If at decisional block 1316 G3 is energized, the process continues along the YES branch to decisional block 1318. As indicated at decisional block 1318, the system determines whether G3 is at SP4.

If at decisional block 1318 G3 is at SP4, the process continues along the YES branch to decisional block 1320. As indicated at decisional block 1320, the system determines whether over-rated capacity is allowed. In one embodiment, system 800 can be configured to operate at an over-rated capacity for a short period of time. If at decisional block 1320 over-rated capacity is allowed, the process continues along the YES branch to marker “B” of FIG. 13b.

If at decisional block 1320 over-rated capacity is not allowed, the process continues along the NO branch to decisional block 1322. As indicated at decisional block 1322, the system determines whether the shaft speed is above a predetermined threshold. In one embodiment, system 800 determines whether the main shaft speed is above 1816 rpm. If at decisional block 1322 the shaft speed is above a predetermined threshold, the process continues along the YES branch to marker “C” of FIG. 13b.

If at decisional block 1322 the shaft speed is not above a predetermined threshold, the process continues along the NO branch to block 1324. As indicated at block 1324, the system adjusts the variable speed drive and the process continues to block 1306, as described above. In one embodiment, system 800 adjusts the variable speed drive of each generator G1, G2, and G3 to maintain the generator speeds at SP4.

FIG. 13b illustrates a high-level flow chart 1301 that depicts logical operational steps performed by, for example, system 800 of FIG. 8 in mode (1) “M1-INC”, which can be implemented in accordance with a preferred embodiment. The process continues from marker B, proceeding to decisional block 1330, wherein the system determines whether generator G1 is at SP5. If at decisional block 1330 G1 is not at SP5, the process continues along the NO branch to block 1332.

As indicated at block 1332, the system increases the set point level of G1 by one set point. The process continues to block 1334. Next, as indicated at block 1334, the system operates in its current configuration for a dwell time, and the process returns to marker A of FIG. 9.

If at decisional block 1330 G1 is at SP5, the process continues along the YES branch to decisional block 1336. As indicated at block 1336, the system determines whether G2 is at SP5. If at decisional block 1336 G2 is not at SP5, the process continues along the NO branch to block 1332.

As indicated at block 1332, the system increases the set point level of G2 by one set point. The process continues to block 1334, wherein the system operates in its current configuration for a dwell time, and the process returns to marker A of FIG. 9.

If at decisional block 1336 G2 is at SP5, the process continues along the YES branch to decisional block 1338. As indicated at block 1338, the system determines whether G3 is at SP5. If at decisional block 1338 G3 is not at SP5, the process continues along the NO branch to block 1332.

As indicated at block 1332, the system increases the set point level of G3 by one set point. The process continues to block 1334, wherein the system operates in its current configuration for a dwell time, and the process returns to marker A of FIG. 9.

If at decisional block 1338 G3 is at SP5, the process continues along the YES branch to block 1340. As indicated at block 1340, the system adjusts the variable speed drive and the process continues to block 1334, as described above. In one embodiment, system 800 adjusts the variable speed drive of each generator G1, G2, and G3 to maintain the generator speeds at SP5. The process continues to block 1334, wherein the system operates in its current configuration for a dwell time, and the process returns to marker A of FIG. 9.

The process also continues from marker C to decisional block 1342. As indicated at decisional block 1342, the system determines whether generator G4 is energized. If at decisional block 1342 G4 is not energized, the process continues along the NO branch to block 1344. As indicated at block 1344, the system energizes generator G4. The process continues to block 1334, wherein the system operates in its current configuration for a dwell time, and the process returns to marker A of FIG. 9.

If at decisional block 1342 G4 is energized, the process continues along the YES branch to decisional block 1346. As indicated at decisional block 1346, the system determines whether generator G5 is energized. If at decisional block 1346 G5 is not energized, the process continues along the NO branch to block 1344. As indicated at block 1344, the system energizes generator G5. The process continues to block 1334, wherein the system operates in its current configuration for a dwell time, and the process returns to marker A of FIG. 9.

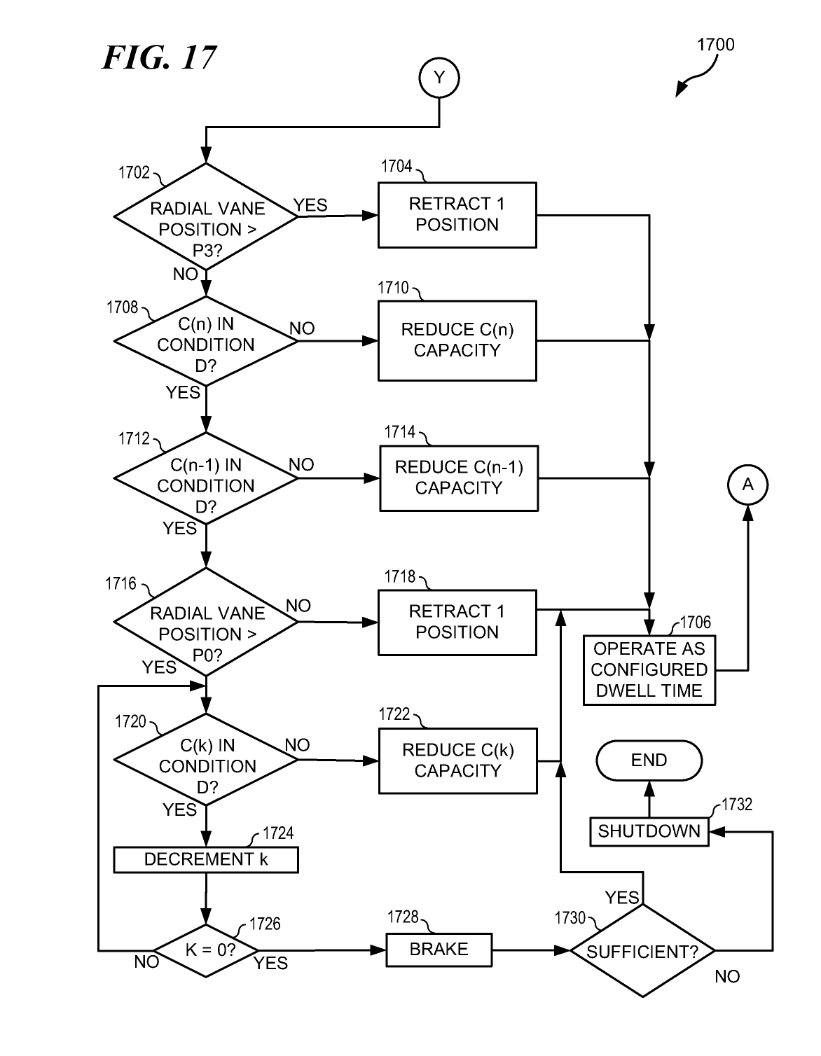

If at decisional block 1346 G5 is energized, the process continues to marker “Y” of FIG. 17, described below.

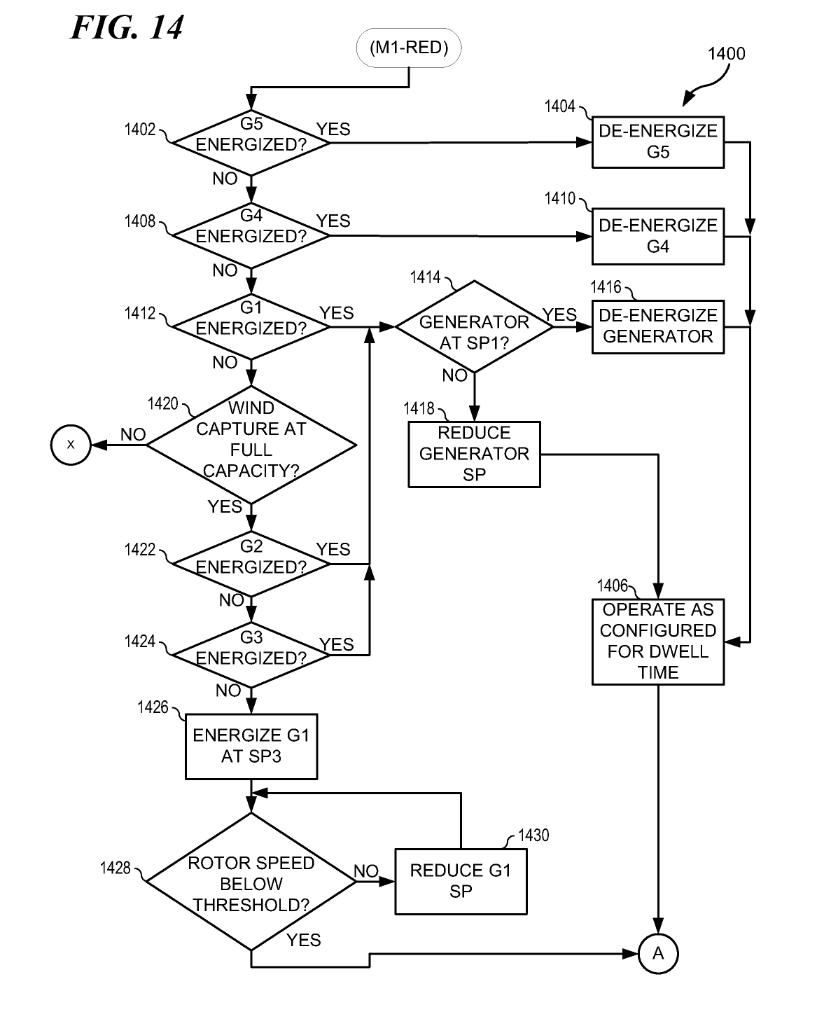

FIG. 14 illustrates a high-level flow chart 1400 that depicts logical operational steps performed by, for example, system 800 of FIG. 8 in mode (1) “M1-RED” (mode (1), shaft speed REDucing), which can be implemented in accordance with a preferred embodiment. In one embodiment, system 800 operates in M1-RED mode when the wind speed is below 15 mph, the main rotor speed is below 10 rpm, and the rotor speed is decreasing by 10 rpm/minute or 20 rpm over a 5 minute period. The process begins at decisional block 1402, wherein the system determines whether generator G5 is energized. If at decisional block 1402 G5 is energized, the process continues along the YES branch to block 1404.

As indicated at block 1404, the system de-energizes G5. Next, as indicated at block 1406, the system operates as configured for a dwell time. In one embodiment, the dwell time is 5 minutes. The process returns to marker A of FIG. 9.

If at decisional block 1402 G5 is not energized, the process continues along the NO branch to decisional block 1408. As indicated at decisional block 1408, the system determines whether generator G4 is energized. If at decisional block 1408 G4 is energized, the process continues along the YES branch to block 1410. As indicated at block 1410, the system de-energizes G4. The process continues to block 1406, as described above, and returns to marker A of FIG. 9.

If at decisional block 1408 G4 is not energized, the process continues along the NO branch to decisional block 1412. As indicated at decisional block 1412, the system determines whether generator G1 is energized. If at decisional block 1412 G4 is energized, the process continues along the YES branch to decisional block 1414.

As indicated at decisional block 1414, the system determines whether generator G1 is operating at SP1. If at decisional block 1414 G1 is operating at SP1, the process continues along the YES branch to block 1416. As indicated at block 1416, the system de-energizes G1. The process continues to block 1406, as described above, and returns to marker A of FIG. 9.

If at decisional block 1414 G1 is not operating at SP1, the process continues along the NO branch to block 1418. As indicated at block 1418, the system reduces the set point at which G1 is operating. In one embodiment, system 800 reduces the set point at which G1 is operating by one set point, such as reducing the set point from SP3 to SP2 for example. In an alternate embodiment, system 800 reduces the set point by two or more set points. The process continues to block 1406, as described above, and returns to marker A of FIG. 9.

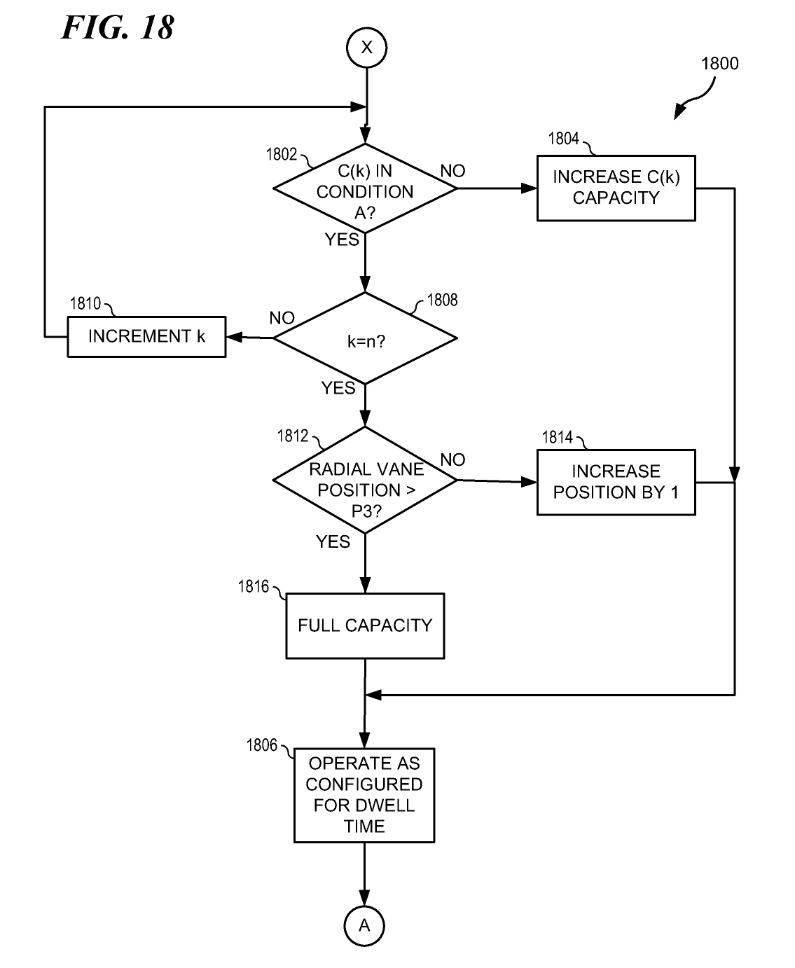

If at decisional block 1412 G1 is not energized, the process continues along the NO branch to decisional block 1420. As indicated at decisional block 1420, the system determines whether the system wind capture capacity is configured at full capacity. If at decisional block 1420 the system wind capture capacity is not at full capacity, the process continues along the NO branch to marker X of FIG. 18, described below.

If at decisional block 1420 the system wind capture capacity is at full capacity, the process continues along the YES branch to decisional block 1422. As indicated at decisional block 1422, the system determines whether generator G2 is energized. If at decisional block 1422 G2 is energized, the process continues along the YES branch to decisional block 1414.

As indicated at decisional block 1414, the system determines whether generator G2 is operating at SP1. If at decisional block 1414 G2 is operating at SP1, the process continues along the YES branch to block 1416. As indicated at block 1416, the system de-energizes G2. If at decisional block 1414 G2 is not operating at SP1, the process continues along the NO branch to block 1418. As indicated at block 1418, the system reduces the set point at which G2 is operating. The process continues to block 1406, as described above, and returns to marker A of FIG. 9.

If at decisional block 1422 G2 is not energized, the process continues along the NO branch to decisional block 1424. As indicated at decisional block 1424, the system determines whether generator G3 is energized. If at decisional block 1424 G3 is energized, the process continues along the YES branch to decisional block 1414.

As indicated at decisional block 1414, the system determines whether generator G3 is operating at SP1. If at decisional block 1414 G3 is operating at SP1, the process continues along the YES branch to block 1416. As indicated at block 1416, the system de-energizes G3. If at decisional block 1414 G3 is not operating at SP1, the process continues along the NO branch to block 1418. As indicated at block 1418, the system reduces the set point at which G3 is operating. The process continues to block 1406, as described above, and returns to marker A of FIG. 9.

If at decisional block 1424 G3 is energized, the process continues along the NO branch to block 1426. As indicated at block 1426, the system energizes G1 at SP3. Next, at decisional block 1426, the system determines whether the rotor speed is below a threshold speed. In one embodiment, the threshold speed is 2.9 rpm.

If at decisional block 1426 the rotor speed is not below a threshold speed, the process continues along the NO branch to block 1430. As indicated at block 1430, the system reduces the set point at which G1 is operating. The process returns to decisional block 1428. If at decisional block 1426 the rotor speed is below a threshold speed, the process continues along the YES branch, returning to marker A of FIG. 9.

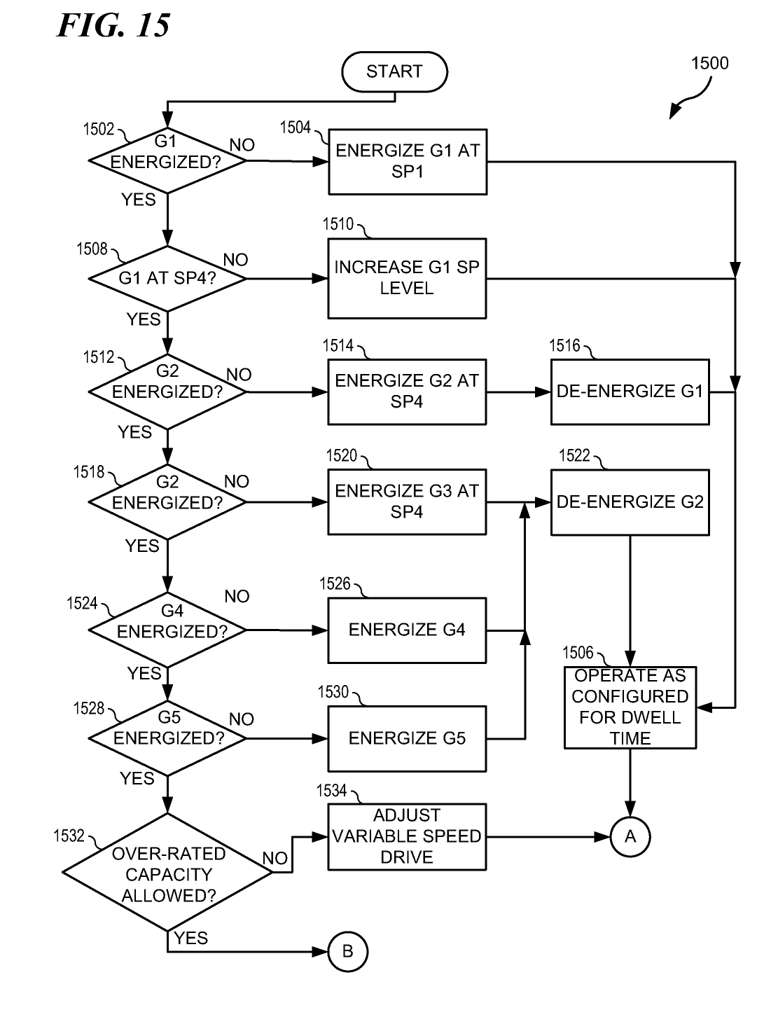

FIG. 15 illustrates a high-level flow chart 1500 that depicts logical operational steps performed by, for example, system 800 of FIG. 8 in mode (2) “M2-INC” (mode (2), shaft speed INCreasing) or mode (3) “M3-INC” (mode (3), shaft speed increasing), which can be implemented in accordance with a preferred embodiment. In one embodiment, system 800 operates in M2-INC (or M3-INC) mode when the shaft speed is increasing more than 5 rpm/minute, or more than 20 rpm over a 5 minute period, or when the generator shaft is operating at above 1860 rpm. The process begins at decisional block 1502, wherein the system determines whether generator G1 is energized. If at decisional block 1502 G1 is not energized, the process continues along the NO branch to block 1504.

As indicated at block 1504, the system energizes G1 at its lowest set point, SP1. Next, as indicated at block 1506, the system operates as configured for a dwell time. In one embodiment, the dwell time is 5 minutes. The process returns to marker A of FIG. 9.

If at decisional block 1502 G1 is energized, the process continues along the YES branch to decisional block 1508. As indicated at decisional block 1508, the system determines whether G1 is at SP4. If at decisional block 1508 G1 is not at SP4, the process continues along the NO branch to block 1510. As indicated at block 1510, the system increases G1's set point by one level, to SP5. The process continues to block 1506 as described above.

If at decisional block 1508 G1 is at SP4, the process continues along the YES branch to decisional block 1512. As indicated at decisional block 1512, the system determines whether G2 is energized. If at decisional block 1512 G2 is not energized, the process continues along the NO branch to block 1514. Next, as indicated at block 1514, G2 is energized at SP4. Next, as indicated at block 1516, the system de-energizes G1. The process continues to block 1506 as described above.

If at decisional block 1512 G2 is energized, the process continues along the YES branch to decisional block 1518. As indicated at decisional block 1518, the system determines whether G3 is energized. If at decisional block 1518 G3 is not energized, the process continues along the NO branch to block 1520. Next, as indicated at block 1520, the system energizes G3 at SP4. Next, as indicated at block 1522, the system de-energizes G2. The process continues to block 1506 as described above.

If at decisional block 1518 G3 is energized, the process continues along the YES branch to decisional block 1524. As indicated at decisional block 1524, the system determines whether G4 is energized. If at decisional block 1524 G4 is not energized, the process continues along the NO branch to block 1526. Next, as indicated at block 1526, the system energizes G4. Next, as indicated at block 1522, the system de-energizes G2. The process continues to block 1506 as described above.

If at decisional block 1524 G4 is energized, the process continues along the YES branch to decisional block 1528. As indicated at decisional block 1528, the system determines whether G5 is energized. If at decisional block 1528 G5 is not energized, the process continues along the NO branch to block 1530. Next, as indicated at block 1530, the system energizes G5. Next, as indicated at block 1522, the system de-energizes G2. The process continues to block 1506 as described above.

If at decisional block 1528 G5 not energized, the process continues along the YES branch to decisional block 1532. As indicated at decisional block 1532, the system determines whether over-rated capacity is allowed. If at decisional block 1532 over-rated capacity is allowed, the process continues along the YES branch to marker “B” of FIG. 13b.

If at decisional block 1532 over-rated capacity is not allowed, the process continues along the NO branch to block 1534. As indicated at block 1534, the system adjusts the variable speed drive and the process continues to marker A of FIG. 9.

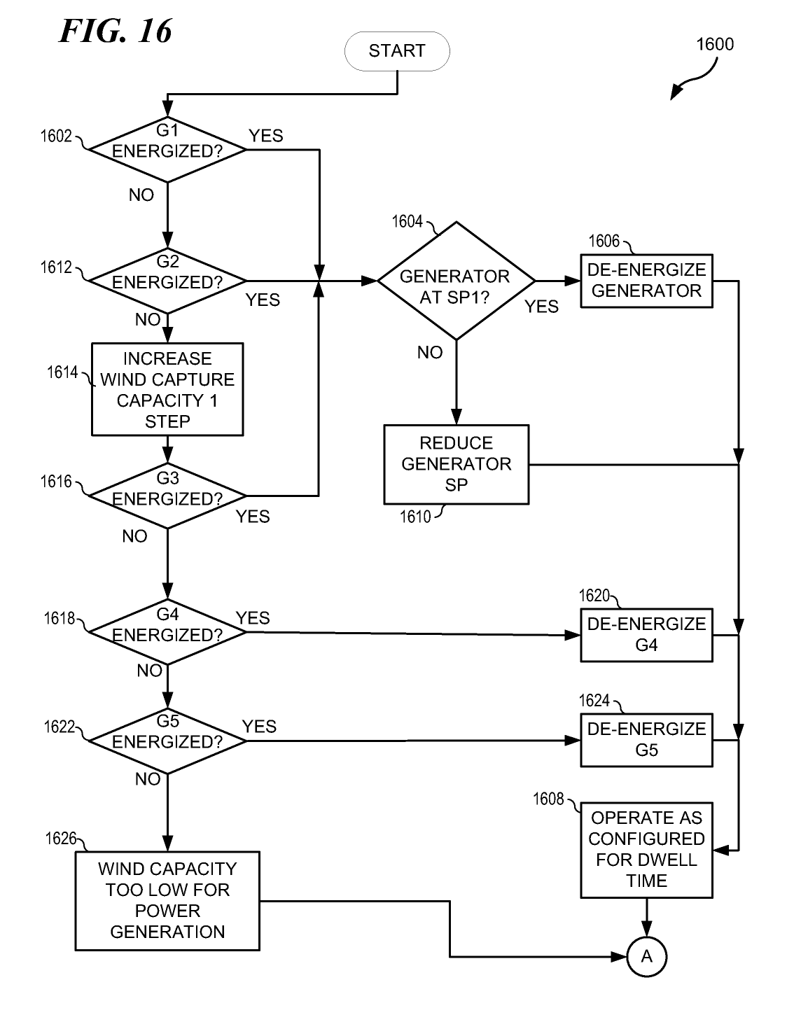

FIG. 16 illustrates a high-level flow chart 1600 that depicts logical operational steps performed by, for example, system 800 of FIG. 8 in mode (2) “M2-RED” (mode (2), shaft speed REDucing) or mode (3) “M3-RED” (mode (3), shaft speed reducing), which can be implemented in accordance with a preferred embodiment. In one embodiment, system 800 operates in M2-RED mode when in operational mode (2) and the wind speed is below 15 mph, the main rotor speed is below 10 rpm, and the rotor speed is decreasing by 10 rpm/minute or 20 rpm over a 5 minute period. The process begins at decisional block 1602, wherein the system determines whether generator G1 is energized. If at decisional block 1602 G1 is energized, the process continues along the YES branch to decisional block 1604.

As indicated at decisional block 1604, the system determines whether generator G1 is operating at SP1. If at decisional block 1604 G1 is operating at SP1, the process continues along the YES branch to block 1606. As indicated at block 1606, the system de-energizes G1. Next, as indicated at block 1608, the system operates as configured for a dwell time. In one embodiment, the dwell time is 5 minutes. In an embodiment operating in mode (3), the dwell time is 3 minutes. The process returns to marker A of FIG. 9.

If at decisional block 1604 G1 is not operating at SP1, the process continues along the NO branch to block 1610. As indicated at block 1610, the system reduces the set point at which G1 is operating. In one embodiment, system 800 reduces the set point at which G1 is operating by one set point, such as reducing the set point from SP3 to SP2 for example. In an alternate embodiment, system 800 reduces the set point by two or more set points. The process continues to block 1608, as described above, and returns to marker A of FIG. 9.

If at decisional block 1602 G1 is not energized, the process continues along the NO branch to decisional block 1612. As indicated at decisional block 1612, the system determines whether generator G2 is energized. If at decisional block 1612 G2 is energized, the process continues along the YES branch to block 1604.

As indicated at decisional block 1604, the system determines whether generator G2 is operating at SP1. If at decisional block 1604 G2 is operating at SP1, the process continues along the YES branch to block 1606. As indicated at block 1606, the system de-energizes G2. The process continues to block 1608, as described above, and returns to marker A of FIG. 9. If at decisional block 1604 G2 is not operating at SP1, the process continues along the NO branch to block 1618. As indicated at block 1610, the system reduces the set point at which G2 is operating. The process continues to block 1608, as described above, and returns to marker A of FIG. 9.

If at decisional block 1612 G2 is not energized, the process continues along the NO branch to block 1614. As indicated at decisional block 1614, the system increases the wind capture capacity by one step, as described in more detail below. Next, as indicated at decisional block 1616, the system determines whether generator G3 is energized. If at decisional block 1616 G3 is energized, the process continues along the YES branch to block 1604.

As indicated at decisional block 1604, the system determines whether generator G3 is operating at SP1. If at decisional block 1604 G3 is operating at SP1, the process continues along the YES branch to block 1606. As indicated at block 1606, the system de-energizes G3. The process continues to block 1608, as described above, and returns to marker A of FIG. 9. If at decisional block 1604 G3 is not operating at SP1, the process continues along the NO branch to block 1618. As indicated at block 1610, the system reduces the set point at which G3 is operating. The process continues to block 1608, as described above, and returns to marker A of FIG. 9.

If at decisional block 1616 G3 is not energized, the process continues along the NO branch to decisional block 1618. As indicated at decisional block 1618, the system determines whether generator G4 is energized. If at decisional block 1618 G4 is energized, the process continues along the YES branch to block 1620. As indicated at block 1620, the system de-energizes G4. The process continues to block 1608, as described above, and returns to marker A of FIG. 9.

If at decisional block 1618 G4 is not energized, the process continues along the NO branch to decisional block 1620. As indicated at decisional block 1620, the system determines whether generator G5 is energized. If at decisional block 1620 G5 is energized, the process continues along the YES branch to block 1624. As indicated at block 1624, the system de-energizes G5. The process continues to block 1608, as described above, and returns to marker A of FIG. 9.

If at decisional block 1626 G5 is not energized, the process continues along the NO branch to decisional block 1626. As indicated at block 1626, the system determines that the wind capacity is low for power generation under the current wind conditions. The process returns to marker A of FIG. 9.

FIG. 17 illustrates a high-level flow chart 1700 that depicts logical operational steps performed by, for example, system 800 of FIG. 8 in reducing wind capture capacity, which can be implemented in accordance with a preferred embodiment. The process begins at marker “Y” and continues to decisional block 1702. As indicated at decisional block 1702, the system determines whether the radial vane is in a position extended farther than position P3. In the illustrated embodiment, system 800 determines whether a single radial vane is in position P3 or higher. In an alternate embodiment, system 800 determines whether any system radial vanes are in position P3 or higher. If at decisional block 1602 the radial vane is extended beyond position P3, the process continues along the YES branch to block 1704.

Next, as indicated at block 1704, the system retracts the radial vane by one position. Next, as indicated at block 1706, the system operates as configured for a dwell time. In one embodiment, the dwell time is 5 minutes. The process returns to marker A of FIG. 9.

If at decisional block 1702 the radial vane is not extended beyond position P3, the process continues along the NO branch to decisional block 1708. As indicated at decisional block 1708, the system determines whether the nth turbine carousel, where n is the number of turbines in the system, is in the closed position, position “D”. If at decisional block 1708 the nth carousel is not in the closed position, the process continues along the NO branch to block 1710. Next, as indicated at block 1710, the system reduces the nth carousel wind capacity by one position, such as, for example, from partially articulating (position “B”) to fixed-half-open (position “C”). The process continues to block 1706, as described above, and returns to marker A of FIG. 9.

If at decisional block 1708 the nth carousel is in the closed position, the process continues along the NO branch to decisional block 1712. As indicated at decisional block 1712, the system determines whether the (n−1)th turbine carousel, where n is the number of turbines in the system, is in the closed position, position “D”. If at decisional block 1712 the (n−1)th carousel is not in the closed position, the process continues along the NO branch to block 1714. Next, as indicated at block 1714, the system reduces the (n−1)th carousel wind capacity by one position. The process continues to block 1706, as described above, and returns to marker A of FIG. 9.

If at decisional block 1712 the (n−1)th carousel is in the closed position, the process continues along the YES branch to decisional block 1716. As indicated at decisional block 1716, the system determines whether the radial vane is in the fully retracted position, position 0. If at decisional block 1716 the radial vane is not in position 0, the process continues along the NO branch to block 1718. As indicated at block 1718, the system retracts the radial vane by one position. The process continues to block 1706, as described above, and returns to marker A of FIG. 9.

If at decisional block 1716 the radial vane is in position 0, the process continues along the YES branch to decisional block 1720. As indicated at decisional block 1720, the system determines whether the kth turbine carousel is in the closed position, position “D”. In the first iteration, k=n−2 and if n−2=0 (that is, there are only two turbines in the system), the process continues at block 1728. Otherwise, if at decisional block 1720 the kth carousel is not in the closed position, the process continues along the NO branch to block 1722. Next, as indicated at block 1722, the system reduces the kth carousel wind capacity by one position, such as, for example, from partially articulating (position “B”) to fixed-half-open (position “C”). The process continues to block 1706, as described above, and returns to marker A of FIG. 9.

If at decisional block 1720 the kth carousel is in the closed position, the process continues along the YES branch to block 1724. Next, as indicated at block 1724, the system decrements k and continues to decisional block 1726. As indicated at decisional block 1726, the system determines whether k=0 (that is, whether they system has determined the operational state of all of the turbines in the system. If at decisional block 1726 k does not equal 0, the process continues along the NO branch, returning to decisional block 1720. If at decisional block 1726 k=0, the process continues along the YES branch to block 1728.

Next, as indicated at block 1728, the system applies one or more brakes. In one embodiment, system 800 engages braking module 842 to reduce the shaft speed of shaft 824. Next, as indicated at decisional block 1730, the process determines whether the braking is sufficient. In one embodiment, braking is sufficient when the shaft rotation begins or continues to decelerate within a predetermined set of parameters. If at decisional block 1730 braking is sufficient, the process continues along the YES branch to block 1706, as described above, and returns to marker A of FIG. 9.

If at decisional block 1730 braking is not sufficient, the process continues along the NO branch to block 1732. Next, as indicated at block 1732, the system shuts down and the process ends. In one embodiment, the system shuts down by declutching all generators, engaging all brakes, retracting all radial vanes, and closing all carousels. In one embodiment, the system enters shutdown mode (10), described in more detail below.

FIG. 18 illustrates a high-level flow chart 1800 that depicts logical operational steps performed by, for example, system 800 of FIG. 8 in increasing wind capture capacity, which can be implemented in accordance with a preferred embodiment. The process begins at marker “X” and continues to decisional block 1802. As indicated at decisional block 1802, the system determines whether the nth turbine carousel, where n is the number of turbines in the system, is in the fully articulated position, position “A”.

If at decisional block 1708 the kth carousel is not in position A, the process continues along the NO branch to block 1804. In the illustrated embodiment, in the first iteration, k=1. Next, as indicated at block 1804, the system increases the kth carousel wind capacity by one position, such as, for example, from fixed-half-open (position “C”) to partially articulating (position “B”). Next, as indicated at block 1806, the system operates as configured for a dwell time. In one embodiment, the dwell time is 5 minutes. The process returns to marker A of FIG. 9.

If at decisional block 1708 the kth carousel is in position A, the process continues along the YES branch to decisional block 1808. As indicated at decisional block 1808, the system determines whether k=n, where n is the number of turbine carousels in operation in the system. If at decisional block 1808 k does not equal n, that is, the system has not evaluated the operational state of each turbine carousel in operation in the system, the process continues along the NO branch to block 1810. As indicated at block 1810, the system increments k and returns to decisional block 1802.

If at decisional block 1808 k=n, that is, the system has evaluated the operational state of each turbine carousel in operation in the system, the process continues along the YES branch to decisional block 1812. As indicated at decisional block 1812, the system determines whether the radial vane is in a position extended farther than position P3.

If at decisional block 1812 the radial vane is not extended beyond position P3, the process continues along the NO branch to block 1814. Next, as indicated at block 1814, the system extends the radial vane by one position. The process continues to block 1806, as described above, and returns to marker A of FIG. 9.

If at decisional block 1812 the radial vane is extended beyond position P3, the process continues along the YES branch to block 1816. As indicated at block 1816, the system determines that the system is a full wind capture capacity. In one embodiment, system 800 indicates to a user that full capacity has been achieved. The process continues to block 1806, as described above, and returns to marker A of FIG. 9.

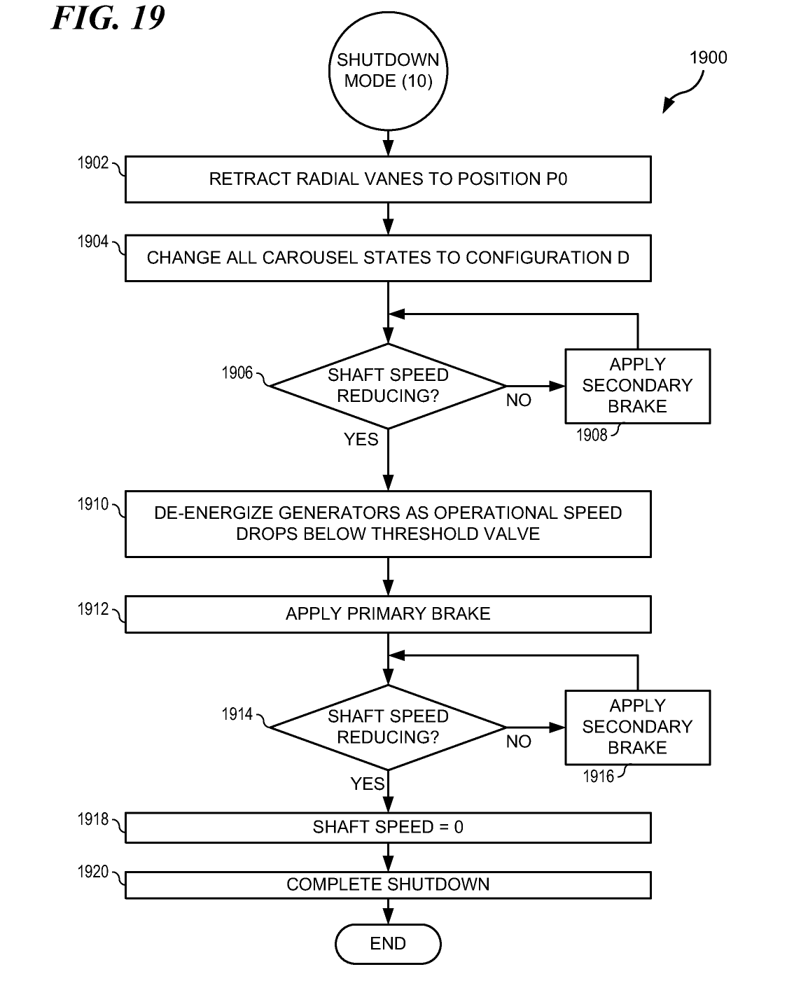

FIG. 19 illustrates a high-level flow chart 1900 that depicts logical operational steps performed by, for example, system 800 of FIG. 8 in shutdown mode (10), which can be implemented in accordance with a preferred embodiment. In one embodiment, system 800 operates in shutdown mode (10) when the wind speed is greater than 65 mph. The process begins at block 1902, wherein the system retracts all radial vanes to position P0 (fully retracted).

Next, as indicated at block 1904, the system changes all carousel operational states to configuration D (closed). Next, as indicated at decisional block 1906, the system determines whether the shaft speed is reducing. If at decisional block 1906 the shaft speed is not reducing, the process continues along the NO branch to block 1908. As indicated at block 1908, the system applies a secondary brake and the process returns to decisional block 1906.

If at decisional block 1906 the shaft speed is reducing, the process continues along the YES branch to block 1910. As indicated at block 1910, the system de-energizes the generators as the generator operational speed drops below a threshold value. In one embodiment, the threshold value is 1800 rpm generator shaft speed. Next, as indicated at block 1912, the system engages a primary brake.

Next, as indicated at decisional block 1914, the system determines whether the shaft speed is reducing. If at decisional block 1914 the shaft speed is not reducing, the process continues along the NO branch to block 1916. As indicated at block 1916, the system applies a secondary brake and the process returns to decisional block 1914.

If at decisional block 1914 the shaft speed is reducing, the process continues along the YES branch to block 1918. As indicated at block 1918, the main drive shaft speed reaches 0 rpm (full stop). Next, as indicated at block 1920, the system completes shutdown. In one embodiment, system 800 completes shutdown by removing power to control systems and engaging locking mechanisms to prevent rotation of the main drive shaft and/or one or more generator shafts.

FIG. 20 illustrates a system 2000 including a plurality of radial vanes in exemplary configurations according to one embodiment. For example, system 2000 includes radial vane module 2002 configured in position 0 (fully retracted). As shown, radial vane enclosure 2020 fully encloses a radial vane (not visible).

System 2000 also includes radial vane module 2004, configured in position 1 (partially extended). As shown, radial vane 2030 has been extended a small distance from enclosure 2020. Similarly, radial vane module 2006 is configured in position 2 (partially extended), in which radial vane 2030 is further extended from enclosure 2020.

System 2000 also includes radial vane module 2008, configured in position 3 (midway extended). As shown, radial vane 2030 is extended from module 2020 approximately half-way between fully extended and fully retracted.

System 2000 also includes radial vane module 2010, configured in position 4 (partially retracted). As shown, radial vane 2030 has been extended close to its maximum distance from enclosure 2020. Similarly, radial vane module 2012 is configured in position 5 (fully extended), in which radial vane 2030 is extended at its maximum extension from enclosure 2020.

FIG. 21 illustrates a system 2100 including a plurality of turbine carousels in exemplary configurations according to one embodiment. For example, system 2100 includes carousel 2110 configured in a fully articulated configuration, configuration “A”. Generally, in a fully articulated configuration, each turbine blade is configured to vary its position relative to the turbine, based on which side the blade is disposed at any given point in its orbit around the turbine axis.

For example, blade 2112 is disposed on the drag side of carousel 2110 and is therefore retracted to its minimal drag position. Similarly, blade 2116 is disposed on the power side of carousel 2110 and is therefore extended to its maximum operational position.

Blade 2114 is disposed on the upwind side of carousel 2110 and is therefore in transition from the retracted position to the extended position. Similarly, blade 2118 is disposed on the downwind side of carousel 2110 and is therefore in transition from the extended position to the retracted position.

Carousel 2120 is configured in a partially articulated configuration, configuration “B”. In one embodiment, configuration B is similar to the fully articulated configuration of carousel 2110, except that the maximum operation position is restricted to something less than the maximum mechanically possible extension. For example, blade 2122 is disposed on the drag side of carousel 2120 and is therefore retracted to its minimal drag position. Similarly, blade 2126 is disposed on the power side of carousel 2120 and is therefore extended to its maximum operational position. However, the maximum operational position of blade 2126 (shown here at approximately 45 degrees) is narrower than the maximum operation position of blade 2116 (shown here at approximately 85 degrees).

Blade 2124 is disposed on the upwind side of carousel 2120 and is therefore in transition from the retracted position to the extended position. Similarly, blade 2128 is disposed on the downwind side of carousel 2120 and is therefore in transition from the extended position to the retracted position.

Carousel 2130 is configured in a fixed-half-open configuration, configuration “C”. As shown, in configuration C, each blade 2132 is fixed in a position midway between fully extended and fully retracted, regardless of whether the blade is presently on the power, drag, upwind, or downwind side of carousel 2130.

Similarly, carousel 2140 is configured in a closed configuration, configuration “D”. As shown, in configuration D, each blade 2142 is fixed in the fully retracted position, regardless of whether the blade is presently on the power, drag, upwind, or downwind side of carousel 2130.

Thus, the disclosed systems and methods provide embodiments that overcome problems and shortcomings of prior art methods. For example, the disclosed embodiments do not suffer failure due to shock loading at rates as high as those of prior art systems and methods. In addition, the disclosed embodiments locate important components of the electricity generation equipment in easily accessible locations, increasing the ability to service and decreasing the time necessary to complete the servicing. Furthermore, the disclosed embodiments provide a system and methodology that allows for the production of electricity at slow wind speeds and allows for scalable electricity production. Finally, the disclosed embodiments provide turbine equipment that suffers less from torsional stresses due to turbine braking.

One skilled in the art will appreciate that variations of the above-disclosed and other features and functions, or alternatives thereof, can be desirably combined into many other different systems or applications. Additionally, various presently unforeseen or unanticipated alternatives, modifications, variations or improvements therein can be subsequently made by those skilled in the art, which are also intended to be encompassed by the following claims.

What is claimed is:

1. A system, comprising:
an enclosure comprising an interior, a drive shaft opening, and a first auxiliary drive shaft opening;
a drive gear disposed within the enclosure;
a first auxiliary gear disposed within the enclosure;
wherein the enclosure aligns the drive gear and the first auxiliary gear such that the drive gear is configured to drive the first auxiliary gear;
wherein the drive gear couples to an end of a drive shaft;
wherein the first auxiliary gear couples to a first end of a first auxiliary drive shaft;
wherein the drive shaft extends from the interior through the drive shaft opening; and
wherein the first auxiliary drive shaft extends from the interior through the first auxiliary drive shaft opening.

2. The system of claim 1, further comprising:
wherein the first auxiliary drive shaft extends parallel to the drive shaft; and
wherein the drive gear and the first auxiliary gear mesh in a parallel configuration.

3. The system of claim 1, further comprising:
a first gearbox coupled to a second end of the first auxiliary drive shaft;
wherein the second end is disposed opposite the first end of the first auxiliary drive shaft;
a first generator drive shaft coupled to the first gearbox and to a first generator; and
wherein the first generator drive shaft is configured to rotate in response to rotation of the first auxiliary gear.

4. The system of claim 3, further comprising:
a turbine coupled to the drive shaft;
wherein the drive shaft is configured to rotate about an axis in response to rotation of the turbine;
wherein rotation of the drive shaft causes the drive gear to rotate; and
wherein the rotation of the drive gear causes the first auxiliary gear to rotate.

5. The system of claim 4, further comprising:
a braking disc coupled to the drive shaft;
a braking module comprising a first braking pad, a second braking pad; and a first braking caliper; and
wherein the first braking caliper is configured to apply the first braking pad and the second braking pad to the braking disc.

6. The system of claim 1, further comprising:
wherein the enclosure further comprises a second auxiliary drive shaft opening;
a second auxiliary gear disposed within the enclosure;
wherein the enclosure aligns the drive gear and the second auxiliary gear such that the drive gear is configured to drive the second auxiliary gear;
wherein the second auxiliary gear couples to a first end of a second auxiliary drive shaft; and
wherein the first auxiliary drive shaft extends from the interior through the first auxiliary drive shaft opening.

7. A system, comprising:
a first drive shaft configured to rotate in response to rotation of a first turbine;
a first braking disc coupled to the first drive shaft;
a first braking module coupled to the first drive shaft, comprising a first braking pad, a second breaking pad, a first braking caliper, and a coupling module;
wherein the first braking caliper is configured to apply the first braking pad and the second braking pad to the braking first disc; and
wherein the first coupling module is configured to couple the first drive shaft to a second drive shaft.

8. The system of claim 7, further comprising:
a second drive shaft configured to rotate in response to rotation of a second turbine;
wherein the first coupling module couples the first drive shaft to the second drive shaft;
a second braking disc coupled to the second drive shaft;
a second braking module coupled to the second drive shaft, comprising a third braking pad, a forth breaking pad, a second braking caliper, and a second coupling module;
wherein the second braking caliper is configured to apply the third braking pad and the fourth braking pad to the second braking disc; and
wherein the second coupling module is configured to couple the second drive shaft to a third drive shaft.

9. The system of claim 7, further comprising a braking control module coupled to the first braking module and configured to engage and disengage the first braking caliper.

10. A method for fluid energy capture, comprising:
monitoring an operational state of a first variable generator, the first variable generator configured to operate at a plurality of set points;
monitoring an operational state of a first fixed generator, the first fixed generator configured to operate at a single set point;
monitoring a shaft speed of a drive shaft;
wherein the drive shaft couples to a vertical turbine disposed in a fluid;
wherein the drive shaft is configured to rotate about an axis in response to rotation of the vertical turbine;
wherein the drive shaft further couples to the first variable generator and the first fixed generator;
monitoring a speed of the fluid;
determining an operational mode based on the drive shaft speed and fluid speed; and
configuring the operational state of the first variable generator and the first fixed generator based on the operational mode.

11. The method of claim 10, wherein the operational mode is configured to promote optimal electricity generation by the first variable generator and the first fixed generator collectively.

12. The method of claim 10, wherein determining an operational mode comprises:
operating in a first operational mode for a dwell time;
comparing the drive shaft speed to a plurality of shaft speed threshold values;
comparing the fluid speed to a plurality of fluid speed threshold values; and
selecting one of a plurality of operational modes based on the comparing the drive shaft speed and the comparing the fluid speed.

13. The method of claim 10, further comprising monitoring an operational state of a radial vane.

14. The method of claim 13, further comprising determining an operational mode based on the drive shaft speed, the fluid speed, and the radial vane operational state.

15. The method of claim 13, further comprising configuring the radial vane operational state based on the operational mode.

16. The method of claim 10, further comprising:
wherein the vertical turbine comprises a carousel, the carousel comprising a plurality of blades; and
monitoring an operational state of the carousel.

17. The method of claim 16, further comprising determining an operational mode based on the drive shaft speed, the fluid speed, and the carousel operational state.

18. The method of claim 16, further comprising configuring the carousel operational state based on the operational mode.

19. The method of claim 10, further comprising:
monitoring an operational state of a shaft brake; and
wherein the shaft brake couples to the drive shaft.

20. The method of claim 12, further comprising configuring the shaft brake operational state based on the operational mode.
